(19) United States
(12) Patent Application Publication
(10) Pub. No.: US 2025/0264491 A1
(43) Pub. Date: Aug. 21, 2025

(54) AUTOMATED ROBOTIC PIPETTOR AND REAGENT COCKTAIL MIXTURE MAKER

(71) Applicant: CYTEK BIOSCIENCES, INC., Fremont, CA (US)

(72) Inventors: Chenyang Jiang, Fremont, CA (US); Ran Cao, Fremont, CA (US); Ming Yan, Fremont, CA (US)

(73) Assignee: CYTEK BIOSCIENCES, INC., Fremont, CA (US)

(21) Appl. No.: 19/054,827

(22) Filed: Feb. 15, 2025

Related U.S. Application Data
(60) Provisional application No. 63/555,092, filed on Feb. 18, 2024.

(51) Int. Cl. G01N 35/10; G01N 35/00; G01N 35/02

(52) U.S. Cl. CPC G01N 35/1002; G01N 35/025; G01N 35/1011; G01N 2035/00445; G01N 2035/103; G01N 2035/1058

(57) ABSTRACT

An automated robotic pipettor and reagent cocktail mixture maker includes a pipette rack to hold pipette tips; reagent racks to hold reagent containers; a buffer rack to hold buffer containers; one or more rotatable test tube mixers to hold one or more mixture test tubes; and an automated robotic arm having an automated syringe pump with an end effector to receive a disposable pipette tip. The automated robotic arm moves pipette tips while the automated syringe pump draws measures of liquid from the various containers into the pipette tip and expels it therefrom into a mixture test tube. The rotatable test tube mixer rotates the mixing tube to mix reagents and buffers together. A cooling system cools the buffers, the reagents, and the reagent mix. But for small openings to receive the pipette tip, a hinged cover covers over the buffers, reagents, and reagent mix to deter cross contamination.

### CROSS-REFERENCE TO RELATED APPLICATIONS

This United States (U.S.) patent application is a nonprovisional patent application claiming priority to U.S. Provisional Patent Application No. 63/555,092, filed on Feb. 18, 2024, by inventors Chenyang Jiang, et al., titled AUTOMATED ROBOTIC PIPETTOR AND REAGENT COCKTAIL MAKER MIXER, incorporated by reference for all intents and purposes.

### FIELD

The embodiments of the invention relate generally to reagent mixers.

### BACKGROUND

Flow cytometry is a technology that provides rapid analysis of physical and chemical characteristics of single cells in a sample solution. Flow cytometers utilize lasers as light sources to produce both scattered and fluorescent light signals that are read by detectors such as photodiodes or photomultiplier tubes. Cell populations can be analyzed and/or purified based on their fluorescent or light scattering characteristics. Flow cytometry provides a method to identify, count, and analyze cells in the sample solution. It is most commonly used for evaluating biological cells in peripheral blood, bone marrow, and other body fluids.

The basic principle of flow cytometry is the passage of biological cells in single file in front of a laser so they can be detected, counted, and sorted. A beam of laser light is directed at a hydrodynamically-focused stream of fluid that carries the cells. Several detectors are carefully placed around the stream, at the point where the fluid passes through the light beam. The stream of fluid is focused so that the cells pass through the laser light one at a time.

In modem flow cytometry, the biological cells are fluorescently labelled and then excited by laser(s) to emit light at varying wavelengths. The fluorescence can then be measured to determine the amount and type of cells present in a sample. In preparation for flow cytometric analysis, single cells in suspension are fluorescently labeled, typically with a fluorescently conjugated monoclonal antibody. Antibodies are stained with a fluorophore (fluorochrome or dye) and introduced to the cell population, where they bind to cell markers.

The fluorescently labelled cell components are excited by the laser and emit light at a longer wavelength than the light source. The detectors therefore pick up a combination of scattered and fluorescent light. The intensity of the emitted light is directly proportional to the antigen density, or the characteristics of the cell being measured. Data from the detectors can then analyzed by a computer using special software. The computer can be coupled in communication with the flow cytometer.

Fluorescence measurements taken at different wavelengths can provide quantitative and qualitative data about fluorophore-labeled cell surface receptors or intracellular molecules such as DNA and cytokines. Most flow cytometers use separate channels and detectors to detect emitted light, the number of which vary according to the instrument and the manufacturer.

Sample availability can often be limited, especially in cases of clinical trial material, when multiple types of testing are required from a single sample or timepoint. Maximizing the amount of information that can be obtained from a single sample not only provides more in-depth characterization of the immune system but also serves to address the issue of limited sample availability.

Reagent kits with vials of various fluorochromes and vials of various antibodies for the different markers (labels) often require advance preparation into one or more test tubes for the desired experiments. Buffer solutions are also used in the advanced preparation. Modem flow cytometers with multiple lasers can allow for numerous different fluorochromes and numerous different antibodies be combined with the biological cells into a one test tube for a single run or a few test tubes for a few test tubes for a few runs through a flow cytometer. With numerous differing fluorochromes and antibodies, the advanced preparation of a reagent solution from a reagent kit with larger numbers can be difficult when manually performed by a lab technician or other user. Manually preparing reagent cocktails for flow cytometry can be time-consuming and error-prone, particularly with high dimensional reagent panels for flow cytometry experiments of biological cells. Mistakes in the manual preparation of a reagent solution can lead to poor results that requires repeating and wastes biological cells that may be in short supply, such as with a patient's blood.

It is desirable to reduce the manual preparation of a reagent solution to avoid mistakes and preserve the sample of biological cells in order to perform efficient flow cytometry analysis of the biological cells.

### BRIEF SUMMARY

The embodiments are summarized by the claims that follow below. However, briefly, in some aspects, the techniques described herein relate to a method for an automated reagent mixer, the method including: picking up a first disposable pipette tip with an end effector of a robotic arm of the reagent mixer from an ordered matrix pipette tip stand holding a plurality of disposable pipette tips; moving the first disposable pipette tip with the robotic arm over a first selected reagent in a first selected reagent container of a plurality of reagent containers in an ordered matrix reagent stand; lowering the first disposable pipette tip with the robotic arm into the first selected reagent container; sucking a measured portion of the first selected reagent from the first selected reagent container into the first disposable pipette tip so it contains a first measured reagent portion; raising the first disposable pipette tip containing the first measured reagent portion with the robotic arm away from the first selected reagent container; moving the first disposable pipette tip containing the first measured reagent portion with the robotic arm over an open end of a first selected one of one or more test tubes respectively in one or more rotatable test tube stands; and pressuring the first measured reagent portion out of the first disposable pipette tip into the first selected one of one or more test tubes.

In some aspects, the techniques described herein relate to a method, further including after pressuring the first measured reagent portion out of the first disposable pipette tip: moving the first disposable pipette tip with the robotic arm over a waste opening into a waste container in the reagent mixer; and releasing the first disposable pipette tip with the end effector of the robotic arm over a waste opening into a waste container in the reagent mixer.

In some aspects, the techniques described herein relate to a method, further including prior to picking up the first disposable pipette tip with the end effector of the robotic arm: placing one or more buffer containers into an ordered buffer stand; placing the plurality of reagent containers into the ordered matrix reagent stand; and placing the one or more test tubes respectively into one or more rotatable test tube stands.

In some aspects, the techniques described herein relate to a method, wherein: the one or more buffer containers and the plurality of reagent containers are from a reagent kit.

In some aspects, the techniques described herein relate to a method, further including: covering around the one or more buffer containers, the plurality of reagent containers, and the one or more test tubes with a hinged housing, wherein the hinged housing has an opening over each of the one or more buffer containers, an opening over each of the plurality of reagent containers, and an opening over the one or more test tubes through which the first disposable pipette tip can extend.

In some aspects, the techniques described herein relate to a method, further including chilling the ordered buffer stand and the ordered matrix reagent stand to preserve contents in the one or more buffer containers and the plurality of reagent containers.

In some aspects, the techniques described herein relate to a method, further including chilling the one or more rotatable test tube stands to preserve contents in the one or more test tubes.

In some aspects, the techniques described herein relate to a method, further including rotating the one or more rotatable test tube stands to rotate the one or more test tubes and uniformly mix liquid contents therein.

In some aspects, the techniques described herein relate to a method, further including chilling the one or more rotatable test tube stands to preserve the contents in the one or more test tubes.

In some aspects, the techniques described herein relate to a method, wherein: the sucking of the measured portion of the first selected reagent from the first selected reagent container into the first disposable pipette tip and the pressuring of the first measured reagent portion into the first selected one of the one or more test tubes is performed with an automated syringe pump coupled in communication with the first disposable pipette tip by a tube with an orifice.

In some aspects, the techniques described herein relate to a method, wherein: the automated syringe pump includes the end effector having the tube with the orifice through which air selectively flows under negative air pressure and positive air pressure.

In some aspects, the techniques described herein relate to a method, further including: after covering with the hinged housing over the one or more buffer containers, the plurality of reagent containers, and the one or more test tubes: closing over a front opening of a housing around the robotic arm, the pipettes, the one or more buffer containers, the plurality of reagent containers, and the one or more test tubes with a hinged front cover, wherein the hinged front cover includes a semi-transparent portion to see movement of the robotic arm within the housing.

In some aspects, the techniques described herein relate to a method, further including: after the raising of the first disposable pipette tip containing the first measured reagent portion and before the moving of the first disposable pipette tip containing the first measured reagent portion with the robotic arm, rotating a drip tray under a tip of the first disposable pipette tip to catch leaking drips out of the first disposable pipette tip; and before pressuring the first measured reagent portion out of the first disposable pipette tip into the first selected one of one or more test tubes, rotating the drip tray out from under the tip of the first disposable pipette tip.

In some aspects, the techniques described herein relate to a method for an automated reagent cocktail maker, the method including: calibrating a Z axis of a robotic arm to a top and a bottom of a reagent container; mounting a first end of a first pipette tip to an end effector of the robotic arm; sensing for a top liquid level in the reagent container at a second end of the first pipette tip opposite the first end; and moving the second end of the first pipette tip along the Z axis from the top of the reagent container to the sensed top liquid level of reagent in the reagent container to determine a dead height of a dead volume in the reagent container; wherein the dead height in the reagent container is a distance of movement of the first pipette tip along the Z axis from the top of the reagent container to the sensed top liquid level of reagent in the reagent container.

In some aspects, the techniques described herein relate to a method, further including determining the dead volume in the reagent container by multiplying the dead height by the circular area predetermined by a diameter of the reagent container.

In some aspects, the techniques described herein relate to a method, further including displaying the dead volume in the reagent container in a graphical user interface by displaying an associated emptiness in a graphical fill within an outline of a container icon.

In some aspects, the techniques described herein relate to a method, further including determining a liquid volume in the reagent container by subtracting the dead volume from a predetermined total volume of the reagent container.

In some aspects, the techniques described herein relate to a method, further including displaying the liquid volume in the reagent container in a graphical user interface by displaying an associated graphical fill within an outline of a container icon.

In some aspects, the techniques described herein relate to a method, further including: calibrating the Z axis of the robotic arm to a top and a bottom of a buffer container differing from the reagent container; sensing for a liquid level in the buffer container at an end of a second pipette tip; moving the end of the second pipette tip along the Z axis of the robotic arm from the top of the buffer container to the sensed liquid level of buffer in the buffer container to determine a dead height of dead volume in the buffer container; wherein the dead height in the buffer container is a distance of movement of the second pipette tip along the Z axis from the top of the buffer container to the sensed top liquid level of buffer in the buffer container.

In some aspects, the techniques described herein relate to a method, wherein the sensing for the top liquid level in the reagent container at the second end of the first pipette tip includes: blowing air out the second end of the pipette tip with a syringe pump; measuring air pressure in the syringe pump; and determining an increase in air pressure when moving the end of the second pipette tip along the Z axis indicating that the top liquid level has been reached.

In some aspects, the techniques described herein relate to a method, further including with the second end of the first pipette tip at the top of the container, measuring capacitance at an end of the first pipette tip; determining a significant change in capacitance when moving the end of the second pipette tip along the Z axis indicating that the top liquid level has been reached.

In some aspects, the techniques described herein relate to a method, wherein: the significant change in capacitance is an increase in measured capacitance.

In some aspects, the techniques described herein relate to a method, wherein: the significant change in capacitance is a decrease in measured capacitance.

In some aspects, the techniques described herein relate to an automated reagent cocktail mixer including: at least one ordered matrix pipette tip stand to hold a plurality of hollow disposable pipette tips; an ordered matrix reagent stand to hold a plurality of reagent containers; one or more rotatable test tube stands to hold one or more test tubes; a robotic arm having an end effector to pick up and engage with a plurality of hollow disposable pipette tips to move them over, in to, out of, and between open ends of the plurality of reagent containers and open ends of the one or more test tubes, the end effector including an orifice to allow air flow into and out each respective one of the plurality of hollow disposable pipette tips; an automated syringe pump in communication with the orifice of the end effector, the automated syringe pump to draw measured portions of selected reagents from open ends of selected reagent containers into the plurality of hollow disposable pipette tips, the automated syringe pump further to expel the measured portions of the selected reagents from the plurality of hollow disposable pipette tips into at least one open end of the one or more test tubes.

In some aspects, the techniques described herein relate to an automated reagent cocktail mixer, wherein the plurality 31, further including: an ordered buffer stand to hold one or more buffer containers. 33B. The automated reagent cocktail mixer further includes: a control processor coupled in communication with the robotic arm and the automated syringe pump; wherein the control processor controls the robotic arm and the automated syringe pump to mix a selected reagent cocktail recipe into the one or more test tubes with a plurality of reagents from the plurality of reagent containers and one or more buffers from the one or more buffer containers.

In some aspects, the techniques described herein relate to an automated reagent cocktail mixer, further including: a housing with a deck and an inner platform coupled to the deck, the inner platform to receive the at least one ordered matrix pipette tip stand, the deck to receive the ordered matrix reagent stand and the one or more rotatable test tube stands; and a hinged cover pivotally coupled to the deck, the hinged housing covering over portions of the plurality of reagent containers, and the one or more test tubes, the hinged housing having a top portion with an opening over each of the plurality of reagent containers, and the one or more test tubes through which an open tip end of the plurality of hollow disposable pipette tips can extend.

In some aspects, the techniques described herein relate to an automated reagent cocktail mixer, further including: a housing with an inner platform to receive the ordered matrix pipette tip stand, the ordered matrix reagent stand, and the one or more rotatable test tube stands; and a hinged cover pivotally coupled to the inner platform, the hinged cover covering over portions of the one or more buffer containers, the plurality of reagent containers, and the one or more test tubes, the hinged cover having a top portion with an openings over each of the one or more buffer containers, each of the plurality of reagent containers, and the one or more test tubes through which an open tip end of the plurality of hollow disposable pipette tips can extend.

In some aspects, the techniques described herein relate to an automated reagent cocktail mixer, further including: an electric chiller under the inner platform, the electric chiller in communication with the ordered buffer stand and the ordered matrix reagent stand to chill and preserve liquid contents in the one or more buffer containers and the plurality 36, wherein: the electric chiller is further in communication with the one or more rotatable test tube stands to chill and preserve liquid contents in the one or more test tubes. 37B. The automated reagent cocktail mixer, further including: a control processor coupled in communication with the electric chiller; and a temperature sensor coupled in communication with the control processor, the temperature sensor to provide temperature feedback to the control processor; wherein the control processor controls the electric chiller to meet a selected temperature based on the temperature feedback.

In some aspects, the techniques described herein relate to an automated reagent cocktail mixer, further including: one or more electric motors respectively coupled to a base of the one or more rotatable test tube stands, the one or more electric motors to rotate the one or more test tubes in the one or more rotatable test tube stands to uniformly mix liquid contents in the one or more test tubes.

In some aspects, the techniques described herein relate to an automated reagent cocktail mixer, further including: a channel coupled in communication with the orifice of the end effector and a barrel of the automated syringe pump, the channel to communicate negative air pressure with a hollow disposable pipette tip mounted to the end effector to draw the measured reagent therein, the channel to communicate positive air pressure with the hollow disposable pipette tip to expel the measured reagent there from.

In some aspects, the techniques described herein relate to an automated reagent cocktail mixer, wherein the robotic arm includes: a rotatable drip tray adjacent the end effector, the rotatable drip tray configured to rotate under an end of a mounted hollow disposable pipette tip to catch leaking drips and avoid cross contamination of reagents.

In some aspects, the techniques described herein relate to an automated reagent cocktail mixer, wherein the housing further includes a front opening, and the automated reagent cocktail mixer further includes: a hinged front door to close over the front opening of the housing, wherein the hinged front door includes a semi-transparent portion to see movement of the robotic arm within the housing.

In some aspects, the techniques described herein relate to an automated reagent cocktail mixer, wherein the housing further includes a front opening, and the automated reagent cocktail mixer further includes: a hinged front cover to close over the front opening of the housing, wherein the hinged front cover includes a semi-transparent portion to see movement of the robotic arm within the housing.

In some aspects, the techniques described herein relate to an automated reagent cocktail mixing system including: an automated reagent cocktail device including: at least one ordered matrix pipette tip stand to hold a plurality of hollow disposable pipette tips; an ordered matrix reagent stand to hold a plurality of reagent containers; one or more rotatable test tube stands to hold one or more test tubes; a robotic arm having an end effector to pick up and engage with a plurality of hollow disposable pipette tips to move them over, in to, out of, and between open ends of the plurality of reagent containers and open ends of the one or more test tubes, the end effector including an orifice to allow air flow into and out each respective one of the plurality of hollow disposable pipette tips; an automated syringe pump in communication with the orifice of the end effector, the automated syringe pump to draw measured portions of selected reagents from open ends of selected reagent containers into the plurality of hollow disposable pipette tips, the automated syringe pump further to expel the measured portions of the selected reagents from the plurality of hollow disposable pipette tips into at least one open end of the one or more test tubes.

In some aspects, the techniques described herein relate to an automated reagent cocktail mixing system, wherein the automated reagent cocktail device further includes: a display monitor to display a graphical user interface; a storage device to store instructions for execution; a processor coupled in communication with the display monitor, the storage device, the one or more rotatable test tube stands, the robotic arm, and the syringe pump, the processor to execute instructions stored in the storage device to perform functions to: control the robotic arm and the syringe pump to mix a selected reagent cocktail recipe into one or more mixture test tubes mounted in the one or more rotatable test tube stands; display a graphical user interface on the display monitor to select the selected reagent cocktail recipe that is to be mixed into the one or more mixture test tubes and display a status of the automated reagent cocktail mixing system as the selected reagent cocktail recipe is being made; and control the one or more rotatable test tube stands to rotate the one or more mixture test tubes.

In some aspects, the techniques described herein relate to an automated reagent cocktail system, wherein the automated reagent cocktail device further includes: an electric chiller in communication with the processor; and a temperature sensor in communication with the processor; wherein the processor is to further execute instructions stored in the storage device to perform functions to control the electric chiller to chill the one or more rotatable test tube stands to a selected temperature setting that is sensed by the temperature sensor, such that the one or more mixture test tubes and the one or more liquid mixtures therein are chilled to preserve the one or more liquid mixtures.

In some aspects, the techniques described herein relate to an automated reagent cocktail system, wherein the automated reagent cocktail device further includes a network interface device coupled in communication with the processor, and the system further includes: a computer system operated coupled in communication with the network interface device of the automated reagent cocktail device; and wherein the processor of the automated reagent cocktail device is to further execute instructions stored in the storage device to perform functions to control the network interface device to communicate with the computer system and display a graphical user interface to one or more authorized users on a display device of the computer system for remote communication and control of the automated reagent cocktail device in the mixing of selected reagent cocktail recipes.

In some aspects, the techniques described herein relate to an apparatus including: a display monitor to display a graphical user interface; a storage device to store instructions for execution; a processor coupled in communication with the display monitor and the storage device, the processor to execute instructions stored in the storage device to perform functions to display the graphical user interface on the display monitor, the functions including: before mixing buffers and reagents with an automated reagent cocktail mixer, displaying a reagent recipe window on the display monitor for a flow cytometer experiment with directions to mount buffer containers with one or more buffers into a buffer rack of the automated reagent cocktail mixer, and mount reagent containers with differing reagents into one or more reagent racks of the automated reagent cocktail mixer.

In some aspects, the techniques described herein relate to an apparatus, wherein the reagent recipe window includes: a list of block names for a buffer rack and each rack of a plurality of reagent racks in an automated reagent cocktail mixer; a virtual block window of a virtual reagent block or a virtual buffer block associated with a selected block associated with a selected block name, the virtual reagent block or the virtual buffer block illustrating a plurality of container icons with reagent names or buffer names adjacent filled container icons that are to be mounted into the selected block associated with the selected block name that is to be filled and no name adjacent empty container icons that are not to be mounted into the selected block associated with the selected block name; a reagent window or a buffer window associated with the selected block name, the reagent window listing detailed information regarding the plurality of reagents to be mounted in a selected reagent block and the buffer window listing detailed information regarding the one or more buffers to be mounted in the buffer block.

In some aspects, the techniques described herein relate to an apparatus, further including before mixing buffers and reagents with an automated reagent cocktail mixer, displaying a new reagent window on the display monitor to enter a new reagent into a data base library of reagents for use in a reagent recipe for a flow cytometer experiment.

In some aspects, the techniques described herein relate to an apparatus, further including before mixing buffers and reagents with an automated reagent cocktail mixer, displaying a cocktail window with information to select a reagent cocktail recipe of a plurality of reagent cocktail recipes.

In some aspects, the techniques described herein relate to an apparatus, further including receiving a selection of a reagent cocktail recipe from the plurality of reagent cocktail recipes to mix reagents for a flow cytometer experiment.

In some aspects, the techniques described herein relate to an apparatus, wherein the cocktail window includes: a recipe window with a plurality of steps for the selected reagent cocktail recipe; and a cocktail deck setting window displaying positions of a plurality of reagent containers of reagents to mount into one or more reagent racks, positions of buffer containers of buffers to mount into a buffer rack, and positions of one or more mixture tubes to mount into one or more removable tube holders.

In some aspects, the techniques described herein relate to an apparatus, wherein the cocktail deck setting window further displays: a virtual image of at least one array of pipette tips with filled in pipette tip icons to show the mounting position into a pipette tip rack receiver.

In some aspects, the techniques described herein relate to an apparatus, wherein the cocktail deck setting window further displays: a virtual image of the buffer rack with filled in vial icons to show the mounting position of buffers into openings in the buffer rack and empty vial icons where no buffer is to be mounted; one or more virtual images of the one or more reagent racks with filled in vial icons to show the mounting position of reagents into openings into the one or more reagent racks and empty vial icons where no reagent is to be mounted; and one or more virtual images of one or more mixing tubes with marked tube icons to show the mounting position of mixing tubes into the one or more removable tube holders and crossed out tube icons where no test tube is to be mounted.

In some aspects, the techniques described herein relate to an apparatus, further including while mixing buffers and reagents with the automated reagent cocktail mixer, displaying a worklist window to show mixing status of a selected reagent cocktail recipe.

In some aspects, the techniques described herein relate to an apparatus, wherein the worklist window includes: a recipe list window of steps for the selected reagent cocktail recipe, a check mark status icon adjacent each step that is completed and a ring status icon indicating a step currently being processed; and a cocktail deck status window showing usage status icons of a plurality of pipette tips in one or more arrays of pipette tips, usage status icons of buffer containers in the buffer rack, and usage status icons of reagent containers in the one or more reagent racks.

In some aspects, the techniques described herein relate to an apparatus, wherein: in a virtual image of the one or more arrays of pipette tips, the usage status icons are a filled in circle to show the presence of a pipette tip and an empty circle to show the absence of a pipette tip;

In some aspects, the techniques described herein relate to an apparatus, wherein: in a virtual image of the buffer containers in the buffer rack, the usage status icons are between a filled vial shape to show a full vial of buffer in the buffer container and an empty vial shape to show an empty vial of buffer in the buffer container.

In some aspects, the techniques described herein relate to an apparatus, wherein: in a virtual image of the reagent containers in the one or more reagent racks, the usage status icons are between a filled vial shape to show a full vial of reagent in the reagent container and an empty vial shape to show an empty vial of reagent in the reagent container.

In some aspects, the techniques described herein relate to an apparatus including: a plastic hollow pipette tip 1000 having a first open end (open tip end) 1011 to receive a measured portion of a selected reagent and a second open 1014 end opposite the first end configured to couple to an end effector of a robotic arm, the plastic hollow pipette tip including: a hollow conical frustrum portion 1001 with the first open end (open tip end) 1011; a middle hollow circular cylinder portion 1002 coupled in communication with the hollow conical frustrum portion 1001, a top hollow circular cylinder portion 1003 having a spherical segment joint 1005 at a first end coupled in communication with the middle hollow circular cylinder portion 1002, the top hollow circular cylinder portion 1003 having a smaller diameter than the middle hollow circular cylinder portion 1002; and a ringed lip 1004 coupled to a second end of the top hollow circular cylinder portion 1003 opposite the first end, the ringed lip 1004 having the second open end 1014 to receive the end effector.

In some aspects, the techniques described herein relate to an apparatus, further including: a plurality of external fins 1013 coupled to the top hollow circular cylinder portion 1003, the plurality of external fins 1013 equally spaced apart around an external circular cylindrical surface of the top hollow circular cylinder portion 1003, wherein the plurality of external fins 1013 extend down a portion of a length of the top hollow circular cylinder portion 1003 away from the ringed lip 1004, the plurality of external fins to suspend the top hollow circular cylinder portion 1003 of the pipette tip above a top surface of a rack for receiving the end effector of the robotic arm.

In some aspects, the techniques described herein relate to an apparatus, further including: a filter 1020 in the top hollow circular cylinder portion 1003, wherein the filter 1020 acts as a barrier to liquid that is sucked up into the hollow conical frustrum portion 1001 and the middle hollow circular cylinder portion 1002 of the plastic hollow pipette tip 1000.

In some aspects, the techniques described herein relate to an apparatus, further including: an end effector 1100 coupled into a portion of the top hollow circular cylinder portion 1003 through the second open end 1014, wherein the end effector 1100 includes a metallic end with an opening through which air can be evacuated up through the plastic hollow pipette tip 1000 to aspirate a selected measure of reagent through the first open end (open tip end) 1011 into the hollow conical frustrum portion 1001 and the middle hollow circular cylinder portion 1002.

In some aspects, the techniques described herein relate to an apparatus, wherein: air can be forced out the opening in the metallic end of the end effector 1100 to push out the selected measure of reagent from the first open end (open tip end) 1011 of the plastic hollow pipette tip 1000.

In some aspects, the techniques described herein relate to an apparatus, wherein: without air, a diameter of the first open end (open tip end) 1011 and a shape of the hollow conical frustrum portion 1001 retains the selected measure of reagent within the plastic hollow pipette tip 1000.

In some aspects, the techniques described herein relate to an apparatus, further including: a rack having a top surface with an array of openings, the rack to receive the plastic hollow pipette tip 1000 into one of the openings with the top surface to engage the plurality of external fins and hold the top hollow circular cylinder portion 1003 of the plastic hollow pipette tip above the top surface of the rack.

In some aspects, the techniques described herein relate to an apparatus, further including: a sealable sterile container having a base and a lid, the base to receive the rack and the plastic hollow pipette tip 1000, the lid to close over the rack and the plastic hollow pipette tip.

In some aspects, the techniques described herein relate to an apparatus, further including: a first capacitor plate 1051A embedded in the hollow conical frustrum portion 1001; a first wire 1052A having a first end coupled to the capacitor plate 1051A routed through the hollow conical frustrum portion 1001, the middle hollow circular cylinder portion 1002, and the top hollow circular cylinder portion 1003; and a first contact terminal 1053A coupled to a second end of the first wire 1052A, the first contact terminal adjacent the ringed lip 1004 to couple to a first contact terminal of an end effector; wherein the first capacitor plate and the first wire are insulated from liquids.

In some aspects, the techniques described herein relate to an apparatus, wherein: the first capacitor plate 1051A of the plastic hollow pipette tip and a metal reagent rack form two capacitor plates of a capacitor to measure liquid volume of a reagent vial mounted in the metal reagent rack.

In some aspects, the techniques described herein relate to an apparatus, further including: a second capacitor plate 1051B embedded in the hollow conical frustrum portion 1001 opposite the first capacitor plate 1051A; a second wire 1052B having a first end coupled to the second capacitor plate 1051B routed through the hollow conical frustrum portion 1001, the middle hollow circular cylinder portion 1002, and the top hollow circular cylinder portion 1003; and a second contact terminal 1053B coupled to a second end of the second wire 1052B, wherein the second contact terminal 1053B adjacent the ringed lip 1004 to couple to a second contact terminal of the end effector; wherein the second capacitor plate and the second wire are insulated from liquids.

In some aspects, the techniques described herein relate to an apparatus, wherein: the first contact terminal and the second contact terminal are shielded from fluids by a friction fit to the end effector.

In some aspects, the techniques described herein relate to an apparatus, wherein: the first capacitor plate and the second capacitor plate of the plastic hollow pipette tip 1000 form a capacitor to measure liquid volume in a reagent vial.

### BRIEF DESCRIPTION OF THE DRAWINGS

Various embodiments are illustrated by way of example, and not by way of limitation, in the Figures of the accompanying drawings.

FIG. 1A is a front perspective view of an automated robotic reagent cocktail maker mixer device/system.

FIG. 1B is a front perspective view of the automated robotic reagent cocktail maker mixer device/system with the front door open showing the interior working space.

FIG. 1C is a back perspective view of the automated robotic reagent cocktail maker mixer device/system.

FIG. 2A is front perspective view of the interior working space of the automated robotic reagent cocktail maker mixer showing the deck with a hinged cover in an open position, the raised pipette platform, and the automated XYZ robotic arm.

FIG. 2B is magnified perspective view of the portion of the deck under the hinged cover shown in FIG. 2A.

FIG. 3 is a magnified perspective view of the waste drawer somewhat pulled out from the base of the automated robotic reagent cocktail maker mixer device/system shown in FIG. 1A.

FIG. 4A is an isolated perspective view of the automated XYZ robotic arm in the interior working space of the automated robotic reagent cocktail maker mixer device/system shown in FIG. 1A.

FIG. 4B is front perspective view of the interior working space of the automated robotic reagent cocktail maker mixer showing the deck with the hinged cover in a closed position, the raised pipette platform, and the automated XYZ robotic arm.

FIG. 4C is a magnified view of a drip tray extending from the base of the Z link of the automated XYZ robotic arm and the end effector with mounted pipette tip extending from the syringe pump over a reagent opening.

FIG. 4D is a magnified view of the drip tray extending from the base of the Z link of the automated XYZ robotic arm and the end effector with mounted pipette tip extending from the syringe pump over a mixture tube opening.

FIG. 5A is an isolated front perspective view of the deck in the interior working space over the cooling system in the base space of the automated robotic reagent cocktail maker mixer device/system shown in FIG. 1A.

FIG. 5B is a back perspective view of that shown in FIG. 5A.

FIG. 5C is an exploded view of that shown in FIG. 5A.

FIG. 6A is magnified front view of the deck with the hinged cover in an open position with the removable buffer rack removed and some of the removable reagent racks removed from the cooling surface of the cooling system of the automated robotic reagent cocktail maker mixer device/system shown in FIG. 5A.

FIG. 6B is an isolated top view of the reagent rack/block shown in FIG. 5A filled with reagent vials/containers having tops removed.

FIG. 7A is a magnified view of the end effector of the syringe pump with a mounted pipette tip and the drip tray extending from the base of the Z link of the robotic arm.

FIG. 7B is a magnified view of the mounted pipette tip and end effector over a mixing tube in the mixing bay of the deck of the automated robotic pipettor device.

FIG. 7C is a schematic view of the automated syringe pump system.

FIG. 7D is a schematic view of the end effector being dipped into a vial/container in a rack/block.

FIG. 7E is a cross-sectional view of the tip of the end effector with a pipette tip mounted thereto.

FIG. 7F is a perspective view of the automated syringe pump pipette tip mounted thereto.

FIG. 8 is a magnified perspective view of differing removable tube holders and different mixing tubes that can be used the coaxial mixers of the automated robotic reagent cocktail maker mixer device/system shown in FIG. 1A.

FIG. 9 is an isolated cross-sectional view from the side of a coaxial mixer for the automated robotic reagent cocktail maker mixer device/system shown in FIG. 1A.

FIG. 10 is a perspective view of a pipette tip.

FIG. 11 is a perspective view of the pipette tip mounted to the end effector of the robotic arm.

FIG. 12 are perspective views of sealed sterile boxes of trays or racks holding an array of a sterile robotic pipette tips.

FIGS. 13A-13C are front views graphical user interface screens/windows displayed by a monitor and a processor executing software instructions of the control software for the automated robotic pipettor device shown in FIG. 1A.

FIGS. 14A-14B are front views additional graphical user interface screens/windows displayed by the monitor and the processor shown in FIGS. 13A-13C executing software instructions of the control software for the automated robotic pipettor device.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments.

The embodiments include a method, apparatus, and system for an automated robotic pipettor device (also referred to as an automated reagent cocktail maker, an automated reagent cocktail mixer, or an automated reagent cocktail device) and components thereof. The automated robotic pipettor device selects reagents from bottles and places them into one or more mixed reagent test tubes (cocktail test tubes mixture tubes or containers) in accordance with reagent cocktail instructions. The device eliminates manual pipetting that would otherwise be performed by a lab technician. The automated robotic pipettor device can further rotate three cocktail test tubes in order to stir (mixes) the cocktail mixture of reagents. It further includes an electronic cooler in its base to keep the reagent bottles, buffering agents, and the cocktail test tubes cold at a set temperature to preserve the liquid contents therein.

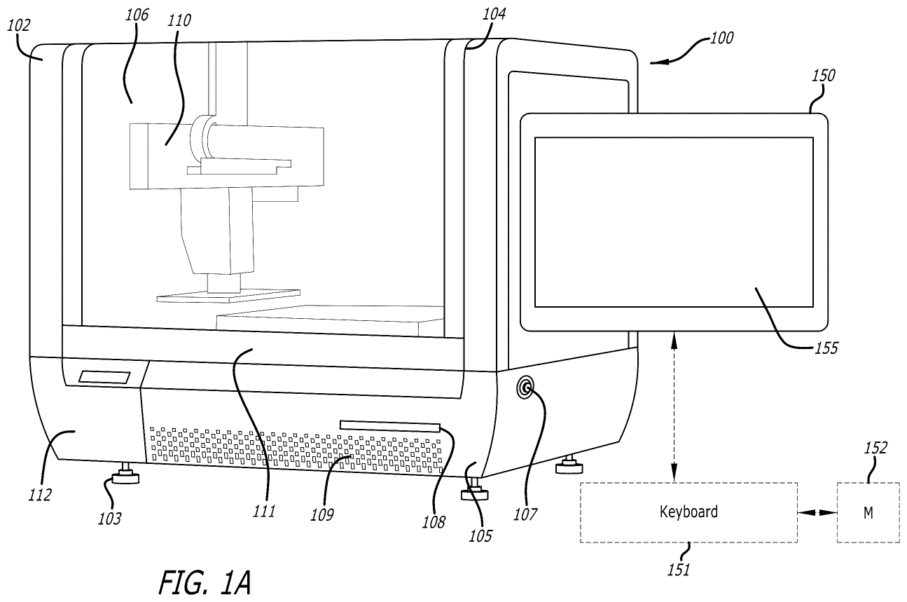

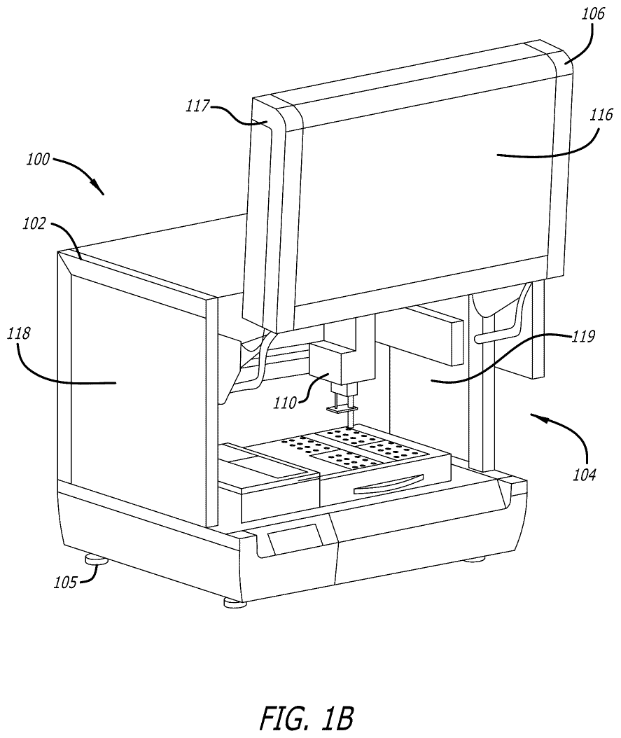

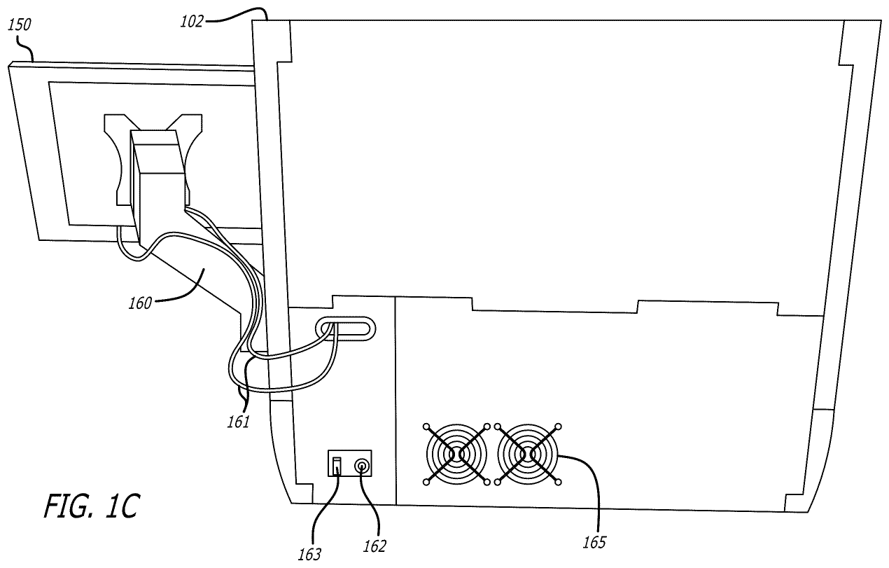

Referring now to FIGS. 1A-1C, an automated robotic pipettor device (as referred to as automated reagent cocktail maker, automated reagent cocktail mixer, automated reagent cocktail device, or simply reagent mixer) 100 of an automated reagent cocktail mixing system are shown. The automated robotic pipettor device 100 is a laboratory instrument that is used to robotically make and mix reagent cocktail mixes for biology experiments on biological cells using other laboratory instruments, such as a flow cytometer or cell sorter. After the automated robotic pipettor device forms one or more reagent cocktail mixes in one or more mixture tubes for one or more biology experiments, the one or more reagent cocktail mixes can be added to test tubes holding the biological cells. That is, biological cells are mixed in test tubes after the one or more reagent cocktail mixes are formed by the automated robotic pipettor device.

The automated robotic pipettor device 100 includes a base, and a housing 102 having a front opening 104 with a front door (hinged front cover) 106. The front door (hinged front cover) 106 includes a handle 111 at its lower edge to lift up on the front door to reveal the front opening 104. The front door (hinged front cover) 106 closes over the front opening 104 in the housing 102 to allow for better cooling of reagents and protect users when a three dimensional (3D—XYZ) robotic arm is moving in the working space therein. As better shown in FIG. 1B, the front door 106 has a dark tinted (semi-transparent) window portion 116 in a frame 117 including the handle 111 to view operation of the robotic arm while protecting the reagents (e.g., fluorescent antibodies) and buffers from room lights. The housing 102 can have a left side window 118 and a right side window 119 that are similarly tinted to provide different angles of view into the working space of the automated robotic pipettor device 100.

The housing 102 has a platform that separates a working space behind the front door 106 and a base space behind a front bezel 105. The housing includes a power button 107 in a side (e.g., backside) of the housing with a status light 108 in the front bezel 105. The status light when on indicates power is provided to the automated robotic pipettor device 100. The status light emitting diode (LED) light can have different colors (e.g., green, yellow, red) to indicate status of the automated robotic pipettor device 100 from sensors and self-testing. A green status light can indicate nominal operation, that everything is fine. A yellow light can indicate some minor troubles, that something needs minor service such as missing pipette tips for example. A red light can indicate a non-operating condition, something is broken, and major service is needed before it can operate, such as a faulty electric motor that needs replacement before the robotic arm can move. The front bezel 105 also includes cooling air vents 109 to allow air flow through the base space below the platform. A waste drawer 112 is in a portion of the base space to one side of the front bezel. A plurality of adjustable feet 103 are coupled to a base of the housing 102 to level it with a surface.

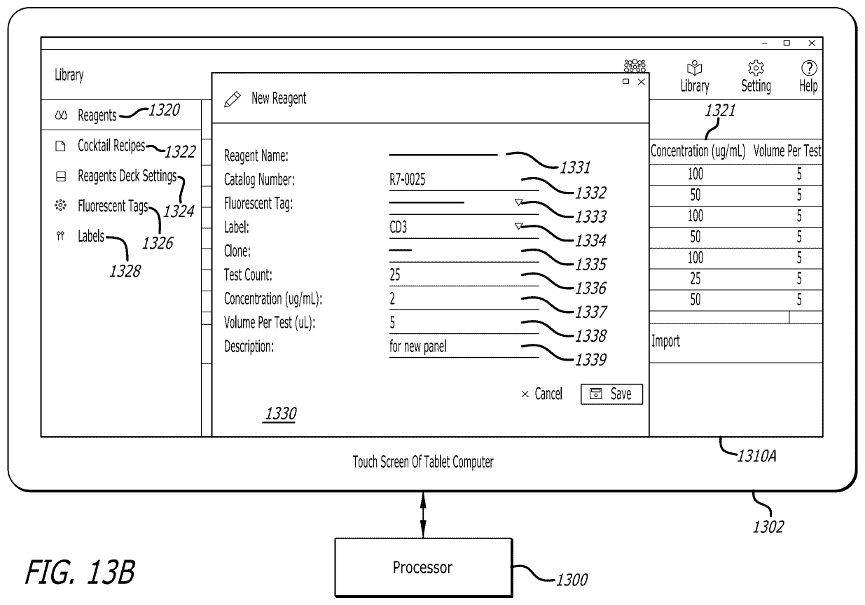

In the working space, the automated robotic pipettor device 100 includes an automated robotic arm 110 with an end effector (see end effector 1100 in FIG. 11). In the working space of the housing, tip plates of detachable short hollow disposable pipette tips, a rack of a plurality of vials or container (vials/containers) of buffers, one or more racks of a plurality of vials/containers of reagents, and one or more mixture test tubes can also be provided. The end effector or the robotic arm can be mated with one of the detachable short hollow disposable pipette tips that the robotic arm can automatically pick up, use, and then dispose of into a hidden container in base space and the waste drawer. The automated robotic arm can move in three dimensions operating to pick up a pipette tip, move it around hauling measures of fluids between vials, containers, and/or test tubes (vials/containers/tubes), and finally drop the used pipette tip into the waste container in the waste drawer.

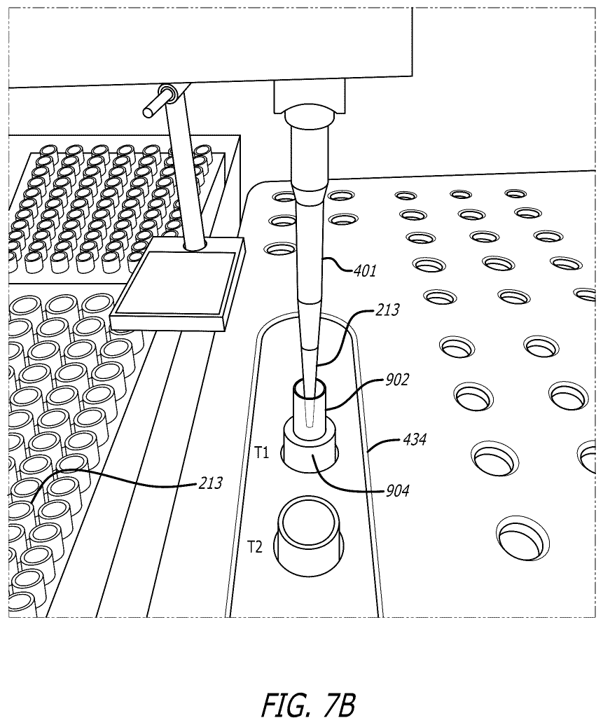

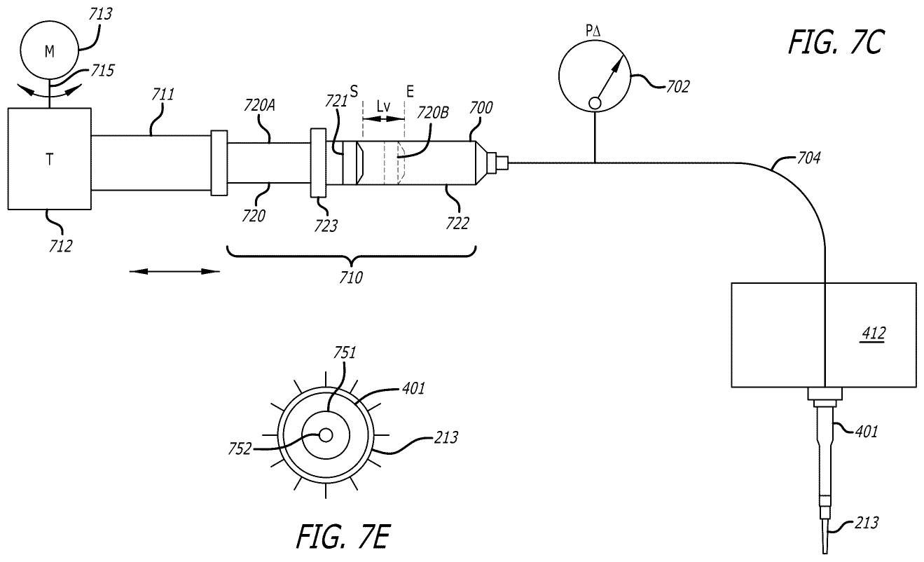

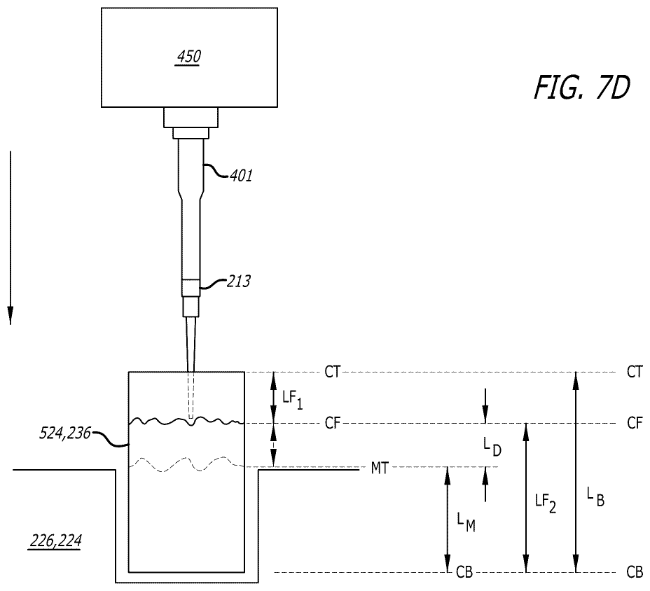

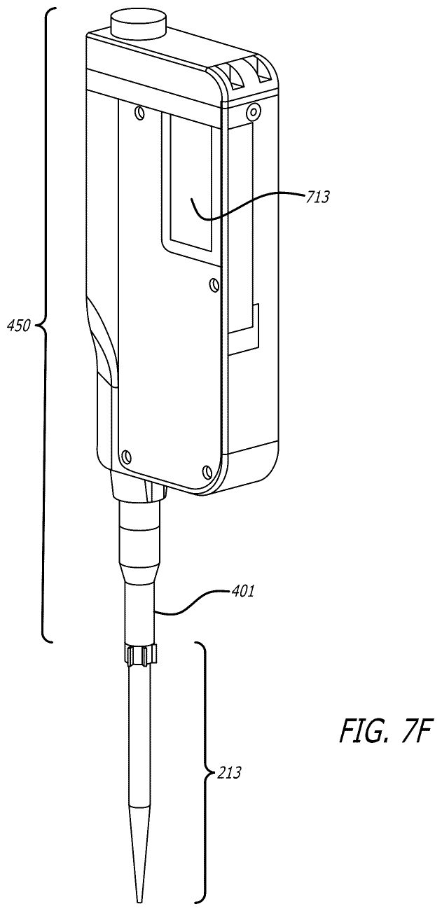

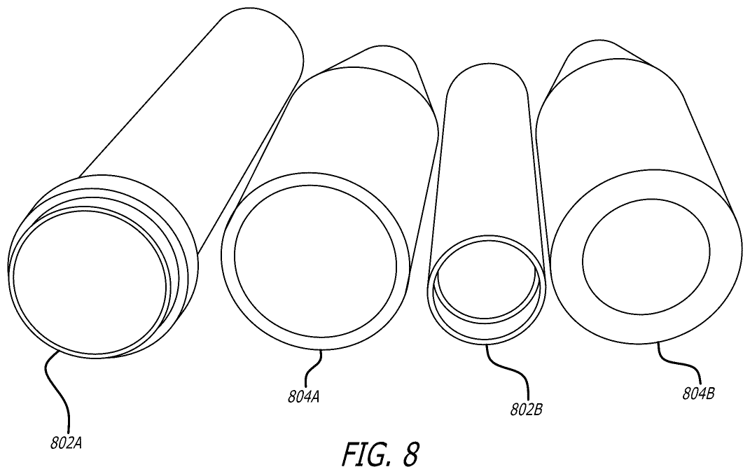

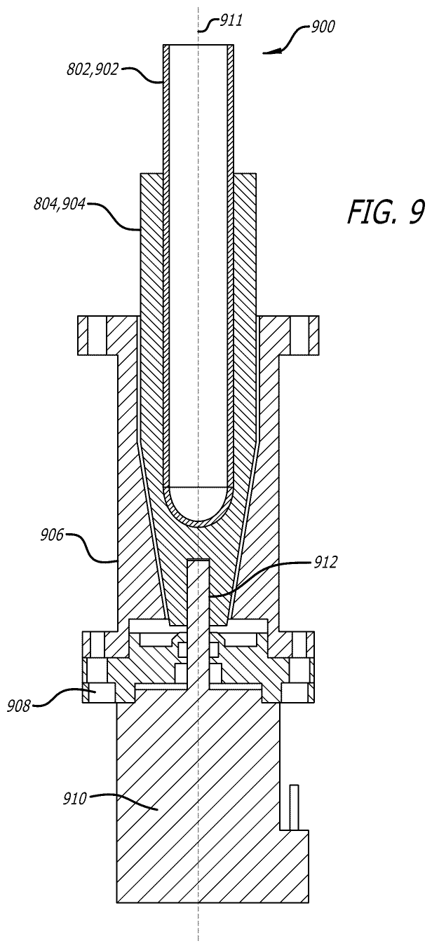

The automated robotic pipettor device 100 further includes an automated mechanical syringe pump (see the automated remote controlled syringe pump 700 shown in FIG. 7C, and the syringe pump 450 shown in FIG. 7F) connected to the end effector (with an orifice) of the robotic arm by tubing or a channel. The automated mechanical syringe pump can slowly provide a negative air pressure (e.g., a vacuum) through an orifice in the end effector of the robotic arm when its plunger is mechanically pulled out from its barrel by a linear actuator. The automated mechanical syringe pump can slowly provide a positive air pressure through the orifice in the end effector of the robotic arm when its plunger is mechanically pushed into its barrel by the linear actuator. The automated mechanical syringe pump is not a manually operated hand pump. As shown by FIG. 7C, the automated mechanical syringe pump is a linear mechanical pump that is mechanically driven by a linear actuator. Furthermore, the automated mechanical syringe pump is not a diaphragm pump, a centrifugal pump, a carboy pump, a magnetic drive pump, an impeller pump, an electric rotary pump, or an electric rotary piston engine pump. The automated mechanical syringe pump can be a programmable syringe pump such as Model ADP 1000 for example sold by Shenzhen Daken Technology Co Ltd. China Patent No. CN213839063U, titled AIR PUMP, issued to Shenzhen Daken Technology Co Ltd. on Jul. 30, 2020, out of China Application No. CN202022462387.6U filed on Oct. 30, 2020, provides exemplary details of an automated mechanical syringe pump 450.

The automated mechanical syringe pump can draw (suck or aspirate) fluids into a pipette tip when the plunger of the syringe is moved in one direction to form negative air pressure (vacuum). The automated mechanical syringe pump can push (blow, force, or expel) out fluid from the pipette tip with positive air pressure when the when the plunger of the syringe is moved in the opposite direction. The piston of the plunger of the automated mechanical syringe pump does not make contact with the liquid fluids in a pipette tip. A filter can be used in the pipette tip to deter contact of aspirated liquids with the end effector of the robotic arm and other components of the syringe pump.

In an elevated portion of the base on the left, there are two blue pipette plates to hold pipette tips and an open oval slot into which used pipette tips can be discarded and captured by a container in a drawer. In the lower portion of the base to the right of the elevated portion, there is an open box shaped cover (hinged cover) that is pivotally coupled to a deck by one or more hinges. The open box shaped cover can cover over the vials/containers of reagents and buffers to hold them in place and avoid cross contamination. The holes in the box cover over the reagent/buffer racks but allow disposable pipette tips to be inserted into the vials/containers. A large oval opening in the open box shaped cover allows the one or more cocktail mixture test tubes (mixing tubes) to be open to the pipette tips so the fluids therein can be released and dropped into the tubes.

The automated robotic pipettor device 100 tries to preserve the contents of the open reagent vials/containers/bottles and open buffer vials/containers/bottles by minimizing light and cross contamination. According, the automated robotic pipettor device 100 provides the hinged open box shaped cover over the reagent vials/containers/bottles and buffer vials/containers/bottles with a small opening in the cover over each location where a vial, container, or bottle may be positioned or located in an opening of a reagent or buffer rack/block (rack, block or stand). The hinged open box shaped cover is opaque to reduce the amount of light that impacts the buffers, reagents, and mixtures while the front door is open.

The automated robotic pipettor device 100 tries to further preserve the contents of the open reagent bottles and open buffer bottles by providing a cold environment to the vials and bottles. Accordingly, the automated robotic pipettor device 100 further includes an electronic cooling device (.g., Peltier cooler) in the base space of the housing. The electronic cooling device cools the buffers in buffer vials (bottles), the reagents in reagent vials (bottles), and the mixtures in the test tubes (bottles) that are seated in various racks, blocks, and mixing devices. A temperature sensor is used in conjunction with the electronic cooling device under the racks/blocks of bottles to maintain a desired temperature setting selected by a user. The temperature setting can be set by user through a temperature input field of a graphical user interface provided by control software executed by a processor.

The automated robotic pipettor device 100 can include a tablet computer 150 attached to a side by a linkage arm coupled there between. The tablet computer 150 has a monitor or display device 155 in communication with a processor to display graphical user interfaces (GUI) generated by automated pipettor control software. The display device 155 can be a touch screen to receive user inputs. Optionally, a keyboard 151 and a mouse 152 can be coupled in communication with the tablet computer 150 to receive user inputs. In another case, a general purpose computer may be coupled to the automated robotic pipettor device 100 with a display device 155, a keyboard 151, and a mouse 152. In some cases, the automated robotic pipettor device 100 can be remotely loaded with reagent recipes for it to mix via network connections and a network interface.

Referring now to FIG. 1B, a perspective view of the automated robotic pipettor device 100 is shown with the front door 106 of the housing 102 in an open position to show the working space therein through the front opening 104. The automated robotic arm 110 is within the working space of the housing 102. The front door 106 includes hinges on each side of its frame coupled to the interior of the housing 102. The hinges are configured to open and close the front door 106 vertically. The front door 106 and hinges can be configured with counter balancing so that the door can hold itself open until the counter balance is overcome by a user by pulling it closed. In another configuration, the front door 106 can be motorized and electronically controlled between open and closed positions. FIG. 1A shows the front door 106 in the closed position over the front opening 104 into the working space.

Referring now to FIG. 1C, a back side of the automated robotic pipettor device 100 is shown. The automated robotic pipettor device 100 includes a mechanical arm 160 coupled to and between a side of the housing 102 and the tablet computer 150 and/or the display device 155. Power, control, and data cables from the housing can be routed to the tablet computer 150 and/or the display device 155 from a back side of the housing 102. The back side of the housing 102 can include a power connector 162 to couple a power cable to a power outlet and a main power switch 163 to switch power on and off to the automated robotic pipettor device 100. The back side of the housing 102 further includes one or more exhaust fan outlets 15 to put air through the base space from the cooling air vents 109 in the front bezel 105 shown in FIG. 1A.

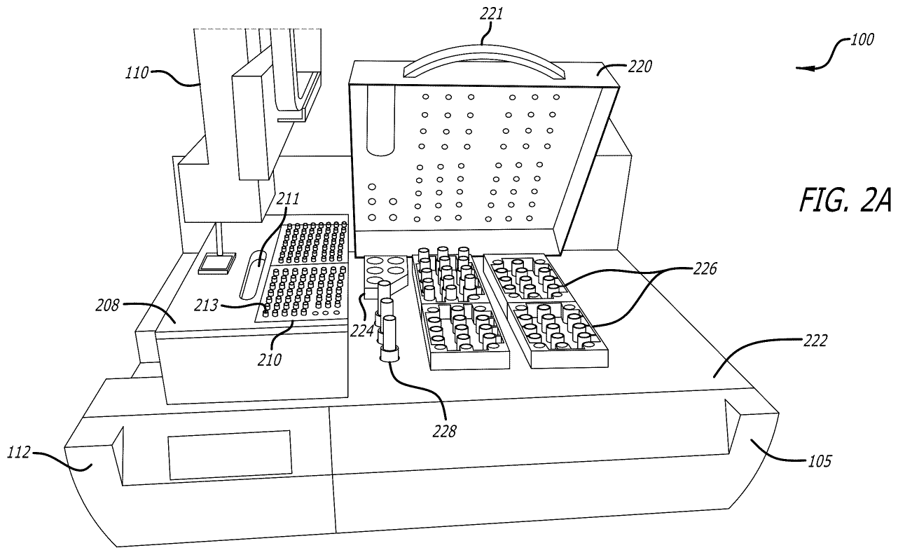

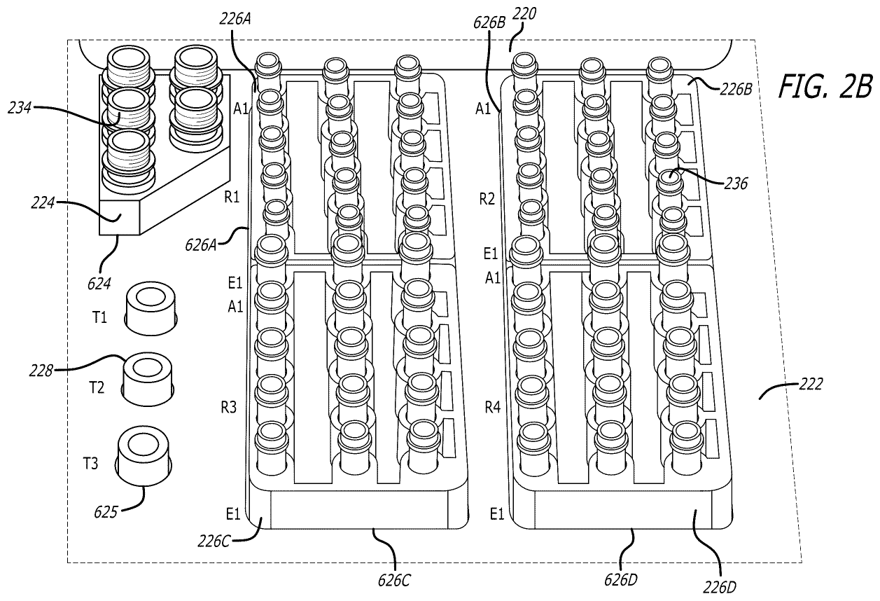

Referring now to FIGS. 2A-2B, a front view of the automated robotic pipettor device 100 is shown with the front door being opened. In the working space, one or two pipette racks (ordered matrix pipette tip stands) 210 with a plurality of disposable pipette tips 213 are mounted in a platform 208 above a deck 222 which may be referred to as the cocktail deck. A hinged cover 220 is pivotally coupled to the deck 222 and shown in an open position. Hinges are coupled to and between the back side of the hinged cover and the deck 222. A handle 221 is coupled to a front side of the hinged cover 220 to open and close it. The hinged cover can be mechanically held in the open position to add vials/container of buffers and reagents into racks/blocks. When closed, edges of the sidewalls of the hinged cover meet the deck 222 forming a perimeter around the reagents, buffers, and mixture test tubes. When closed, the top surface of the hinged cover substantially covers around the containers/vials but for small openings to allow pipette tip access and an oval opening to allow liquids to fall into mixture test tubes. When the cooling system is operating, the hinged cover deters room air from warming the vials/containers of reagents and buffers, as well as the tubes of the cocktail mixtures in order to preserve their contents. When closed, the hinged cover deters cross-contamination between reagents, buffers, and mixtures in the one or more test tubes. When closed, the hinged cover is opaque to substantially keep light from striking the vials/containers and tubes to preserve their contents.

The deck 222 includes openings to receive a removable buffer rack/block 224, a plurality of removable reagent racks/blocks (ordered matrix reagent stands) 226, and one or more removable tube holders 228. The buffer rack/block (ordered buffer stand) 224 can receive a plurality of buffer containers/vials. The reagent racks/blocks 226 can receive a plurality of reagent containers/vials. The one or more removable tube holders 228 can receive one or more cocktail mixture test tubes. The buffer rack/block 224 and the reagent racks/blocks 226 rest on a cooling surface of the cooling system that can cool the buffers and reagents to preserve their contents. Each of the one or more removable tube holders (one or more rotatable test tube stands) 228 rest on a coaxial spinner/mixer below the deck 222. Electric motors of the coaxial spinner/mixers gently spin mixture tubes mounted in the adapter tubes to mix different reagents/buffers of a reagent cocktail recipe together. Portions of the coaxial spinners/mixers can be cooled (chilled) as well by being coupled to the cooling surface of the cooling system to preserve the buffer/reagent mixed liquid contents within test tubes mounted into the removable tube holders (one or more rotatable test tube stands) 228.

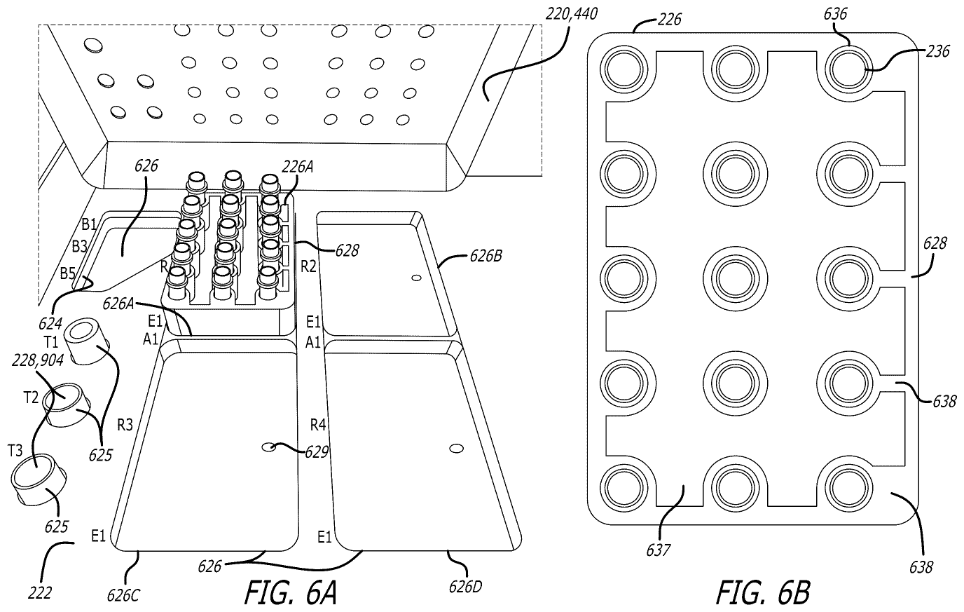

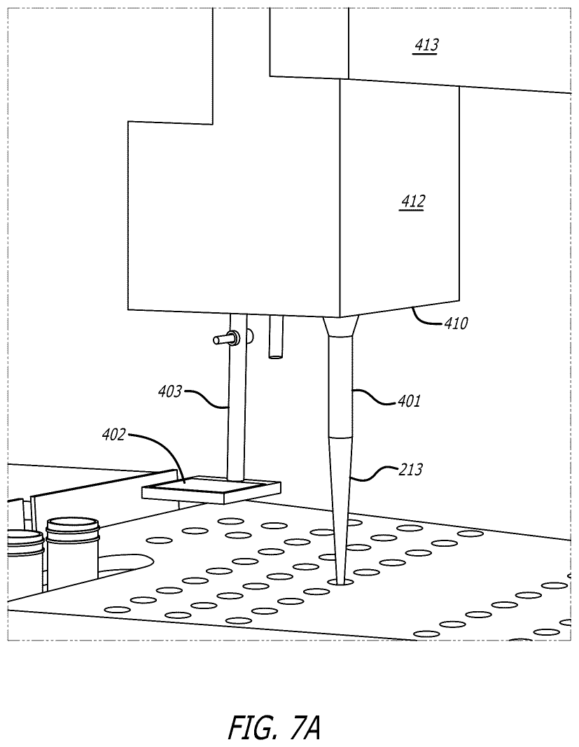

Referring now to FIGS. 2B and 6A, the buffer rack/block 224 and the reagent blocks/racks 226A-226D are inserted through openings in the deck 222 to rest on and removably couple to a cooling surface. For the buffer rack/block 224, the deck 222 has an opening (buffer cooling bay) 624 that substantially matches the perimeter of the buffer rack/block 224. Adjacent the buffer rack opening are the buffer container numbers B1, B3, and B5 on top of the deck. The buffer rack/block is useful for stain buffers and blocking buffers for use in the reagent cocktail recipes.

For the reagent blocks/racks 226A-226D, the deck 222 has two or more openings 626A-626D substantially matching the perimeter of two or more of the reagent blocks/racks 226A-226D. Adjacent the reagent rack openings 626A-626D are rack numbers R1, R2, R3, and R4 on the top of the deck. The deck immediately around each reagent rack opening 626A-626D can have a different color in order to color code the rack openings to a color on the reagent rack/block. Additionally adjacent the two corners of the reagent rack openings are the vial numbers A1 and E1 for each rack. For the removable tube holders 228, the deck 222 has circular openings 625 for each that is around the outer diameter of the removable tube holders 228. Adjacent the circular openings 625 in the deck 222 are the test tube numbers T1, T2, and T3 on the top of the deck.

Each reagent rack/block has openings that can accommodate antibody-conjugate tubes with volumes about 0.5 milliliters (mL) to 2.0 mL per tube. In accordance with some embodiments, each reagent rack/block has fifteen openings arranged in three columns and five rows to reagent vials/tubes/containers. With four reagent racks/blocks, sixty different reagents can be mounted to the deck in the automated robotic pipettor device 100 so that sixty different reagents can be used for creating reagent recipes in the cocktail mixture tubes.

Referring momentarily now to FIG. 6A, the orientation of the buffer rack/block 224 and the reagent racks/blocks 226A-226D mounted on the respective cooling surfaces 626 in the cooling bays 624,626A-626D is assured so that the software properly controls the automated robotic arm to pick the proper reagents for a reagent cocktail recipe. Accordingly, the reagent racks/blocks 226A-226D are keyed to the reagent cooling bays 626A-626D to avoid improper orientation. Each reagent rack has a key bit 628 and the reagent cooling bay has a matching keyway 629 so the orientation of alphanumeric positions for the vials/containers is proper. A portion of each reagent rack can have a different color for color coding to match that used on the deck around each reagent rack opening so the reagent racks/blocks do not get mixed up. The buffer rack/block 224 has a perimeter shape that is keyed to the perimeter shape of the buffer cooling bay 624 to avoid improper orientation. With the proper orientation in the buffer cooling bay 624 and the reagent cooling bays 626A-626D, the control software for the automatic robotic arm will know how to select the proper reagents and proper buffers from the vials/bottles positioned within the blocks/racks.

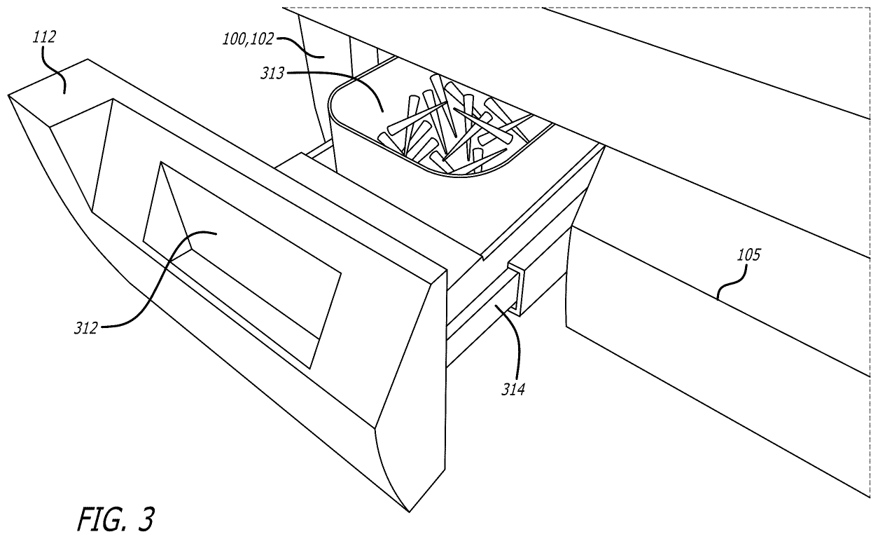

Referring now to FIG. 3, the waste drawer 112 adjacent the front bezel 105 of the housing 102, is shown partially pulled out from the automated robotic pipettor device 100. The waste drawer 112 receives a removable waste container 313 that receives the used pipette tips 213 dropped by the automated robotic arm 110 through the waste slot 211. The waste drawer 112 includes a front drawer panel 312 with a grip handle. The waste drawer 112 further includes drawer sliders 314 on each side to slide it into and out of the housing 102 to gain access to the removable waste container 313 of the automated robotic pipettor device 100.

### Automated Robotic Arm

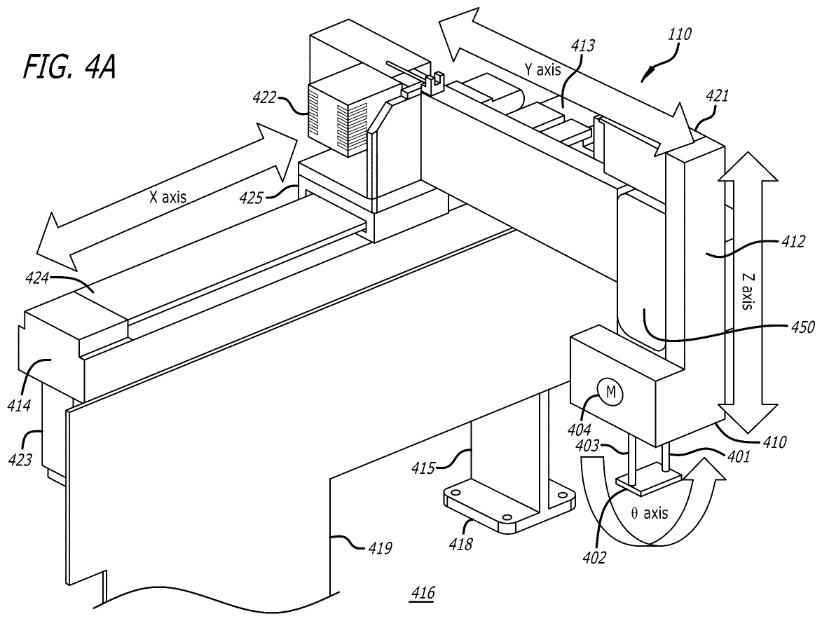

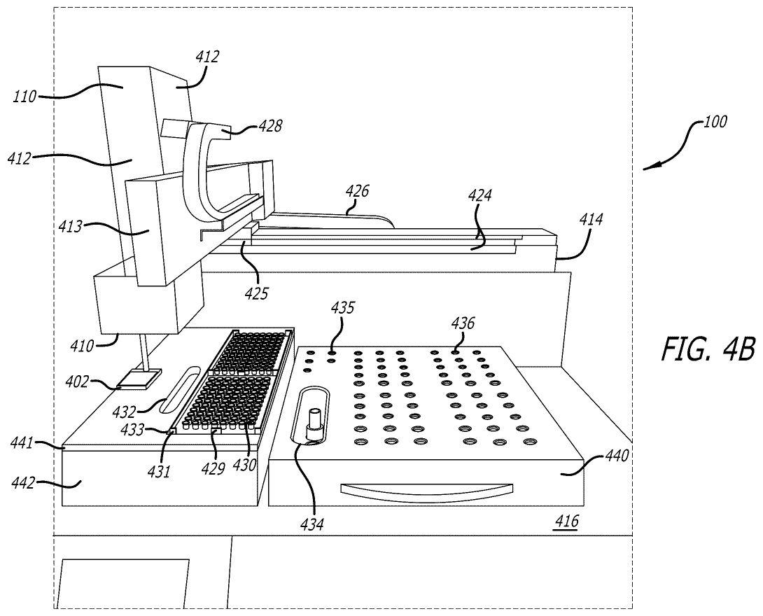

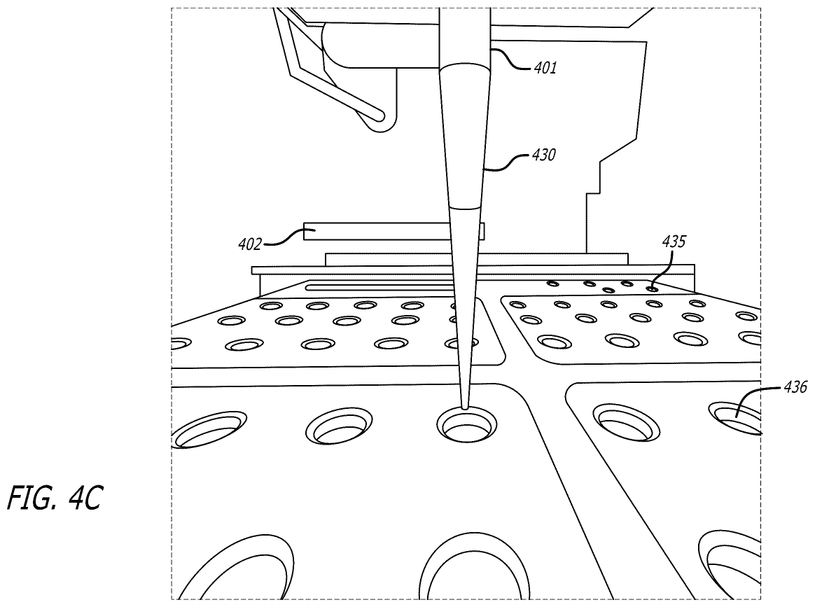

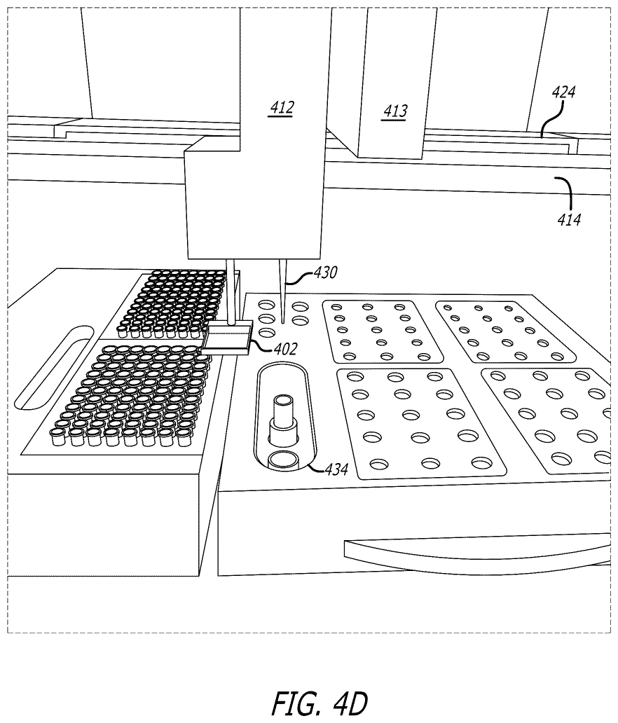

Referring now to FIG. 4A, a perspective view of the automated robotic arm 110 in the automated robotic pipettor device 100 is shown. In response to a reagent recipe, the automated robotic arm 110 can linearly move in three dimensions (X axis, Y axis, and Z axis) to move a syringe pump 450 and its end effector 401 over the deck in the working space of the automated robotic pipettor device 100. The end effector 401 includes an orifice coupled in communication with the syringe pump 450. The end effector 401 moves out away from a wrist end 410 of the Z link 412 as the syringe pump 450 slides along rails in the Z link. The syringe pump 450, with its the end effector 401, is moved vertically up and down in the Z axis direction by a Z servo motor 421. The syringe pump 450 is coupled to a slider that slides on rails along the Z link 412. The Z servo motor 421 includes an encoder to readily keep track of movement and vertical travel of the syringe pump 450 with a pipette tip mounted to the end effector 401.

Adjacent the end effector 401 is a rotatable drip tray 402 extending from the wrist end 410 of the Z link 412 of the automated robotic arm 110. The rotatable drip tray 402 is coupled to a rotatable shaft 403 extending from the wrist end. After the syringe pump 450 and end effector 401 are moved up together so the end of the pipette tip is out of the way, the rotatable drip tray 402 can rotate around a theta axis along a rotatable shaft 403. The rotatable drip tray 402 extends a predetermined distance down from the wrist end 410 of the Z link 412. The distance can be manually adjustable during calibration. A servo motor 404 in a wrist housing can be coupled to the rotatable shaft 403 to control the rotation of the rotatable drip tray 402. With the syringe pump 450 and the end effector 401 moved up near the top of the Z link, the rotatable drip tray 402 can be rotated under a pipette tip mounted to the end effector 401. The drip tray can catch drops of reagent that may leak from the end of the pipette tip to deter cross contamination as the automated robotic arm 110 moves over other differing reagents before releasing the captured reagent into a mixture tube.

The automated robotic arm 110 includes links 412-415, guides, and rails coupled serially together to support the end effector 401 over the deck 416. The deck 416 can provide a ground link for the automated robotic arm 110. A support beam 415 is mounted to the deck 416 with a mount 418 and fasteners through each corner hole in the mount. The support beam 415 is coupled to the deck through the mount 418 at one end and the linear guide rails 424 of the X link 414 at an opposite end. A secondary support beam 419 can provide another point of coupling to the ground link of the deck for the linear guide rails 424 of the X link 414. The Y link 413 is slidingly coupled to the X link 414 through the linear slide guide 425 and the linear guide rails 424. The Z link 412 can be slidingly coupled to the Y link 413 through a similar linear slide guide and linear guide rails. The syringe pump 450 can be mounted to a linear slide guide that is slidingly coupled to linear guide rails of the Z link 412 for vertical movement of the pump, end effector, and any pipette tip mounted thereto.

A plurality of stepper motors or servo motors 421-423 can be used to linearly move the end effector 401 in three dimensions over the deck 222,416. The syringe pump 450 and the links 412-413 can linearly move in a respective axis direction with linear guide rails and linear slide guides. For example, the X link 414 includes two linear guide rails 424 and the Y link 413 includes a linear slide guide 425 to slide along the linear guide rails 424 and move along the X axis. The linear slide guide 425 is coupled to an oval belt between the two linear guide rails that is looped between a driver gear/pulley on a shaft coupled to the X servo motor 423 at one end and an idler pulley and/or gear at an opposite end of the X link 414. A similar configuration can be used between the Y link 413 and Z link 412, The Y servo motor 422 can be used to move a linear slide guide of the Z link 412 in the Y axis direction over the linear guide rails of the Y link. The Z servo motor 421 can be used to move a linear slide guide coupled to the syringe pump 450 in the Z axis direction over linear guide rails of the Z link.

Referring now to FIG. 4B, the automated robotic arm 110 is shown in the working space in the housing of the automated robotic pipettor device 100. The automated robotic arm 110 is mounted to the deck 416 within working space of the housing. The Z link 412 of the automated robotic arm 110, the end effector, and rotatable drip tray 402 are shown located near the left portion of the interior working space. The pipette tip has been dropped by the automated robotic arm into the tip waste opening 432 above the waste container below the deck 416.

In FIG. 4B, the linear slide guide 425 is engaged with the linear guide rails 424. A first flexible cable guide 426 guides power, ground, sense, and control electrical cables from the deck 416 of the housing over X link 414 to the Y link 413. A second flexible cable guide 428 guides power, ground, sense, and control electrical cables over the Y link 413 to the Z link 412, the servo motor 404, and the syringe pump 450 as needed. The electrical cables to the X servo motor 423 and other sensors in the X link 414 need not be guided because it is fixed in place to the deck 416.

A hinged reagent compartment cover 440 is hinged to the deck 416 at a back side by hinges. A handle in a front side of the hinged reagent compartment cover 440 allows it to be opened and closed. The hinged reagent compartment cover 440 substantially covers over the buffer vials and the reagent vials mounted in blocks near the surface of the deck, leaving buffer openings 435 and reagent openings 436 in a top surface. The buffer openings 435 and reagent openings 436 allow a pipette tip to be inserted down below the cover into a vial. The top surface of the reagent cover further has a mixture tube opening 434 around the one or more mixture test tubes to allow a pipette tip to release fluids into the tubes. The hinged reagent compartment cover 440 helps avoid cross contamination between reagent vials, keeps light from damaging the reagents, and helps to better control the temperature around the vials to preserve the reagents therein.

One or two pipette racks 431, each with an X-Y array of a plurality of pipette tips 430, can be mounted to a raised platform 441. The one or more pipette racks 431 are mounted into one or more pipette rack openings 433 in the raised platform 441. The one or more pipette racks 431 can be fixed to the raised platform 441 in the openings by clip fasteners 429 at each end. The raised platform 441 is above the deck 416 and coupled to edges of one end of an open ended box 442 that in turn has an opposite end coupled to the deck 416. The raised platform 441 allow the tips of the pipettes in the pipette racks to extend below into the open ended box 442. The raised platform 441 and the open ended box 442 help preserve sterilization of the pipette tips 430 in the pipette racks 431 by keeping other objects from touching them. The tip waste opening 432 is in the raised platform 441 to allow the automated robotic arm to drop a used pipette tip into the waste container. With the end effector 401 lacking a pipette tip, the automated robotic arm is ready to pick up a new unused pipette tip 430 from the pipette rack 431 with the end effector 401.

Referring now to FIG. 4C, the automated robotic arm 110 has positioned the end effector 401 with mounted pipette tip 430 over a reagent opening 436. The distal open end of the mounted pipette tip 430 can be raised and lowered into the reagent of a reagent vial under the opening having a center axis aligned with the center of the opening. The end effector 401 is part of the syringe pump 450. The syringe pump 450 and end effector 401 can be moved together up and down (vertically) within the Z link 412. The syringe pump 450 and end effector 401 are moved down to pick up a pipette tip and then can move back up with the pipette tip attached thereto. The syringe pump 450 and end effector 401 move down automatically together in order to remove a used pipette tip from the end effector and drop it into the waste opening. The syringe pump 450 and end effector 401 can be moved down into a vial or container in order to draw a liquid into the pipette tip and moved up out of the vial or container to deposit the liquid into a test tube or other container.

Referring now to FIG. 4D, the automated robotic arm 110 moves the links so that the syringe pump 450 with the end effector 401 and mounted pipette tip 430 is positioned above an opening into a mixture tube. The mixture tube is positioned in advance under the mixture tube opening 434 of the hinged reagent compartment cover 440. The automated robotic arm 110 positions a center axis of the mixture tube in alignment with a center axis of the pipette tip 430 in order to drop a selected reagent or buffer into the mixture tube. The automated robotic arm 110 rotates the rotatable drip tray 402 out from under the end of the pipette tip 430 before the selected reagent or buffer is forced out and dropped into the mixture tube.

### Cooling System

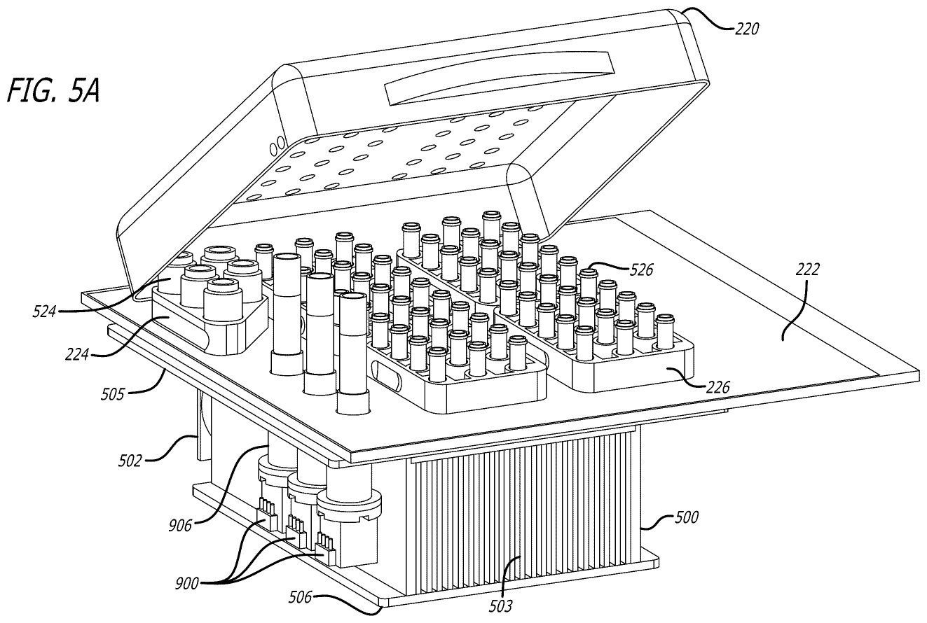

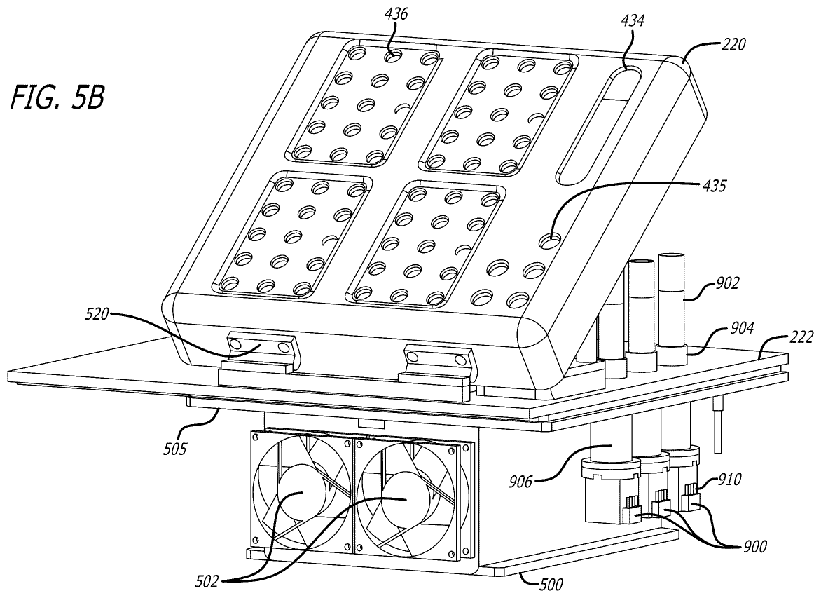

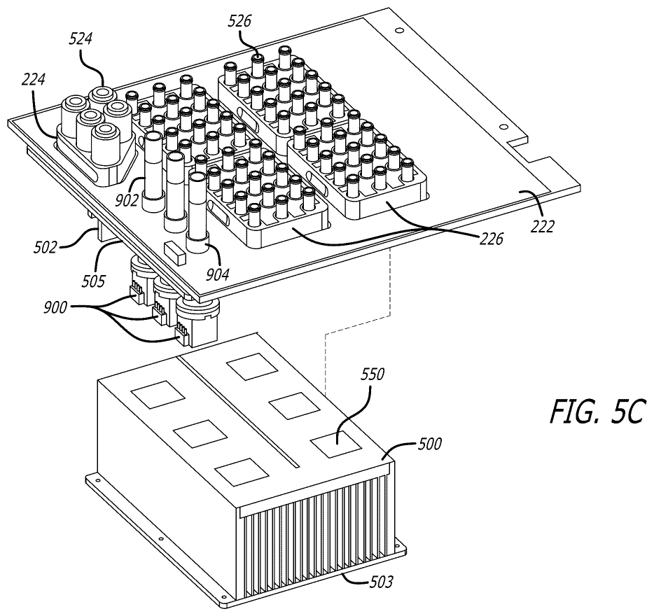

Referring now to FIGS. 5A-5C, the automated robotic pipettor device 100 has a cooling system (electric chiller) to preserve the reagents and buffers in their respective containers/vials and the mixing tubes into which a reagent cocktail recipe is mixed.

The automated robotic pipettor device 100 includes an electronic cooler 550 in its base space to keep the reagent bottles, buffering agents, and the cocktail test tubes cold at a set temperature to preserve them. A temperature sensor is within the working space of the housing 102 of the automated robotic pipettor device 100 in order to provide feedback to a temperature controller and maintain a set temperature selected by the user with the graphical user interface displayed by the automated pipettor control software. The cooling system 500 includes cooling fins 503 between a cooling plate 505 and a mounting plate 506. The cooling system 500 further includes the electronic cooler 550 under the cooling plate 505 that exhausts heat into the cooling fins 503. In accordance with one embodiment, the electronic cooler 550 is a six square electric Pelter cooler. The cooling system 500 has cooling fans 502 mounted to the back side adjacent the cooling fins 503. The cooling fans 502 pull air into the base space through the air holes in the front bezzle, through the cooling fins 503, and then pushes the hot air out through the exhaust outlets 165 in the backside of the housing.

The buffer rack/block 224 and the reagent racks/blocks 226 are formed of a heat conductive material, such as metal (e.g., aluminum), so it can be chilled to respectively conduct heat away from the buffer vials/containers 524 and the reagent vials/containers 526 inserted therein. When mounted in the working space, the bases of the buffer rack/block 224 and the reagent racks/blocks 226 are removably mounted onto a top side of the cooling plate 505 of the cooling system through the openings in the deck 222 to conduct heat away from the mounted vials/containers and the fluids therein.

As shown in FIGS. 5B-5C, the automated robotic pipettor device 100 includes one or more coaxial mixers 900 to stir the reagent mix in mixture test tubes 902. Each coaxial mixer 900 includes a hollow removable tube holder 904 with a top portion that extends above the deck 222 to receive the mixture test tube 902. The cocktail mixture test tube can be of different sizes, such as five milliliters (ml) and fifteen milliliters of fluid capacity or volume. Below the deck 222, each coaxial mixer further includes an electric motor 910 with a shaft in communication with the removable tube holder 904. A mix assembly adapter 906 of each coaxial mixer is coupled to and between the electric motor 910 and a bottom surface of the cooling plate 505 to hold the coaxial mixer.

The inner surface of the removable tube holder 904 is in contact with the mixing tube so that it can conduct heat away from the mixture test tube 902 and the fluid contents therein. An outer surface of the removable tube holder 904 is in close proximately (adjacent) to an inner surface of the mix assembly adapter 906 to transfer heat away from the removable tube holder into the assembly adapter. A small gap allows the removable tube holder 904 to coaxially spin while the mix assembly adapter 906 is fixed. The mix assembly adapter 906 is coupled to the bottom surface of the cooling plate 505 to conduct heat away from the mixture test tube 902 and the fluid contents therein. Accordingly, the cooling plate 505, the mix assembly adapter 906, and the test removable tube holder are formed of heat conducting materials, such as metal (e.g., aluminum or steel).

FIG. 5B better shows the hinged reagent compartment cover 220,440 with a pair of hinges 520 coupled to and between the back side of the hinged cover and the deck 222. The top surface of the hinged reagent compartment cover 220,440 includes the mixture tube opening 434, the buffer openings 435 for the buffer rack/block, and the arrays of reagent openings 436 for each reagent rack/block.

Referring now to FIG. 6A, a chemical bay in the deck 222 for buffers, reagents and mixing tubes is shown under the hinged reagent compartment cover 220,440. The mixing tubes are absent from the removable tube holders 228,904. The buffer block/rack is missing to show the cooling surface 626 in the buffer cooling bay 624. Three reagent blocks/racks are missing to show the cooling surfaces 626B-626D under them. A reagent block/rack 226A is removably mounted onto the cooling surface 626 in the reagent cooling bay 626A. With the buffer block/rack and the reagent blocks/racks being removably mounted to their respective cooling surfaces, vials/containers of buffers/reagents can be loaded external to the automated robotic pipettor device 100, such as on a bench and can be stored in a refrigerator. When ready to mix the reagents into a mixing tube in advance of a flow cytometer experiment, the buffer block/rack and the reagent blocks/racks with their respective vials/containers can be mounted onto the respective cooling surfaces and mixing tubes loaded into the appropriate removable tube holders.

As mentioned herein, the orientation of the buffer rack/block 224 and the reagent blocks/racks 226A-226D mounted on the respective cooling surfaces 626 in the cooling bays 626A-626D is assured so that the software can properly control the automated robotic arm to pick the proper reagents for a reagent cocktail recipe. The reagent racks 226A-226D can be keyed to the reagent cooling bays 626A-626D to avoid improper orientation. The reagent racks/blocks 226A-226D can also be respectively labeled R1,R2,R3,R4 and the deck 222 similarly labeled so the reagent blocks/racks are placed in the proper reagent cooling bays 626A-626D.

Referring now to FIG. 6B, a top view of a reagent rack/block 226 is shown with a plurality of reagent vials 236 mounted into a plurality of vial openings 636. The vial openings 636 are formed in an X-Y array in the reagent rack/block 226. The reagent rack/block 226 can have labels adjacent the vial opening identifying its position within the rack/block. In one embodiment, the corners can have the labels such as A1 in the upper left hand corner, A3 in the upper right hand corner, E1 in the lower left corner, and E3 in the lower right corner. In another embodiment, one or more of the perimeter edges of the rack/block can have labels. For example, the left edge from top to bottom can be labeled A1 through E1 respectively adjacent each vial openings 636. The right edge from top to bottom can be labeled A3 through E3 respectively adjacent each vial openings 636. For example, the top edge from left to right can be labeled A1, A2, and A3. The bottom edge, for example, can be labeled from left to right E1, E2, and E3 adjacent each via opening 636. If anyone edge of the rack/block with labels is viewed by a user, they gain an understanding of how to position the appropriate vials of reagents into the respective vial openings of a given rack/block for the reagent cocktail recipe. Each of the plurality of reagent vials 236 can have their lids removed (twisted off or pulled off) before being positioned within the vial openings 636.

Each rack/block has openings 637 so conductive material around a vial opening 636 can conduct heat down into the base of the rack/block. Furthermore, each rack/block has ridges 638 coupled to the sides in order to direct heat from a vial opening into sides of the rack/block and into the base. With the base of the rack/block mounted onto a cooling surface of the cooling system, the heat can be directed further down into the fins of the cooling system in the base space of the automated robotic pipettor device 100.

### End Effector and Drip Tray

Referring now to FIG. 7A, a magnified perspective view of the Z link (end link) 412 of the automated robotic arm 110 is shown. The end effector 401, part of the syringe pump 450, extends below the base or wrist end 410 of the Z link 412. A pipette tip 213 is removably mounted to a distal end of the end effector 401 and located over a reagent opening by the automated robotic arm, ready to move downward into a reagent vial/container with the syringe pump 450 to draw in fluids. The pipette tip 213, end effector 401, and syringe pump 450 (pipette tip/effector/syringe pump) vertically move down and up with respect to the Z link 412 in response to the Z servo motor 421.

From a proximal end, the rotatable shaft 403 for the rotatable drip tray 402 extends from the base or wrist end 410 of the Z link 412. The rotatable shaft 403 is coupled to and between a stepper motor in the Z link 412 and the rotatable drip tray 402. The stepper motor in the Z link 412 causes the shaft 403 to pivot (rotate) the rotatable drip tray 402 under the pipette tip 213 to control drips as the automated robotic arm moves the end effector 401. The rotatable drip tray 402 can be rotated under the open tip end of the pipette tip to catch leaking drips, if any, out of the pipette tip as it is moved about. The stepper motor rotates the rotatable shaft 403 and the rotatable drip tray 402 out from under the pipette tip 213 when in a proper position before drawing (sucking) reagent in from a reagent vial or before pushing (expelling) reagent out into a mixing tube.

Referring now to FIG. 7B, the stepper motor has rotated the rotatable shaft 403 and the rotatable drip tray 402 out from under the pipette tip 213. The syringe pump 450 and end effector 401 can be moved up and down (vertically) together with respect to the Z link 412 to extend the pipette tip 213 into a top portion of a mixture test tube 902 resting in the removable tube holder 904. The automated syringe pump 450 can be controlled to push reagent in the pipette tip 213 out into the mixture test tube 902. The syringe pump 450 and end effector 401 can be similarly moved up and down (vertically) together with respect to the Z link 412 to extend the pipette tip 213 into a top portion of a reagent vial in a reagent rack/block and a buffer vial in the buffer block/rack. With the end of the pipette tip 213 in the fluid of a vial/container, the automated syringe pump 450 can then be automatically controlled to suck reagent/buffer into the pipette tip 213. The pipette tip 213 has an air tight mount to the end effector 401. As air is drawn in through the orifice of the end effector 401 by the automated syringe pump, fluids can be drawn into the pipette tip 213. As air is forced out through the orifice of the end effector 401 by the automated syringe pump, fluids in the pipette tip 213 can be pushed out.

### Fluid Volume Sensing

With the end of a pipette tip 213 in the reagent of a reagent vial, the automated syringe pump can be controlled to suck up a measured volume of reagent into the pipette tip. With the end of a pipette tip 213 in the buffer of a buffer vial, the automated syringe pump can be controlled to suck up a measured volume of buffer into the pipette tip. The automated robotic arm 110 can receive feedback as to the volume of liquid sucked into a pipette tip 213. Each pipette tip can hold a fluid volume between one microliter to one thousand microliters of reagent or buffer, one at a time. A new pipette tip can be used each time fluid is moved from a reagent/buffer container into a mixture tube.

FIG. 7F is a perspective view of the automated syringe pump 450 isolated from the automated robotic pipettor device 100 but with a pipette tip 213 mounted to the end effector 401. The automated syringe pump 450 includes an electric servo motor 7133 coupled to a shaft by pullies and a belt to rotate the shaft clockwise and counter clockwise. The shaft is a screw drive and includes a threaded screw that is threaded into a threaded nut. In one direction of rotation, the electric servo motor 713 rotates the shaft with the threaded screw into the nut to push on a plunger in a hollow barrel to provide positive air pressure at the end of the pipette tip to push liquids out. In an opposite direction of rotation, the motor rotates the shaft with the threaded screw out of the nut to pull out the plunger in the hollow barrel in order to provide negative air pressure at the end of the pipette tip and draw liquids in. The automated syringe pump 450 can include a number of built in sensors including a pressure sensor to measure air pressure, and a capacitance meter to measure capacitance for electrical level sensing.

Referring now to FIGS. 7C, a schematic diagram of a syringe pump system for the automated robotic pipettor device 100 is shown to describe the functionality of the syringe pump 450. The syringe pump system includes the automated remote controlled syringe pump 700 having a hollow barrel 722 coupled in communication with a pressure sensor 702 and an end of a tube/hose/channel 704. An opposite end of the tube/hose/channel 704 is coupled in communication with the orifice of the end effector 401. A pipette tip 213 is mounted to the end effector 401. The automated remote controlled syringe pump 700 includes a syringe pump 710, a linear actuator 711, a transmission 712, and an electric servo motor 713 with a rotatable shaft 715. The electric servo motor 713 is reversable and coupled in communication to a control processor to control the rotations of the rotatable shaft 715. The rotatable shaft 715 is coupled to the transmission 712 that receives its rotations and converts it into linear motion of the linear actuator 711. The transmission 712 can be a rack and pinion type of transmission, for example, that converts rotational motion into linear motion.

The syringe pump 710 includes a plunger 720 and a hollow barrel 722. One end of the plunger includes a seal 721 that slides inside the hollow barrel 722 as the plunger is linearly moved. Another end of the plunger is coupled to an end of the linear actuator 711 to linearly move the plunger back and forth between a start position S 720A and an end position E 720B over a linear distance Lv in order to draw a volume of fluid into the end of the pipette tip and to push out the volume of fluid from the end of the pipette tip. The linear distance Lv is proportional to the volume of fluid to draw in from a reagent vial and to push out into the mixture tube in accordance with the reagent recipe.

Referring momentarily to FIG. 7E, the pipette tip 213 is mounted to the end effector 401 near its tip end 751. The tip end 751 of the end effector has an orifice 752 coupled in communication with the automated remote controlled syringe pump 700 to receive air pressure therefrom. To draw fluid into the pipette tip 213, the orifice 752 of the end effector will receive negative air pressure from the automated remote controlled syringe pump 700. To force fluid out of the pipette tip, the orifice 752 of the end effector receives positive air pressure from the automated remote controlled syringe pump 700.

The automated syringe pump can be automatically controlled to suck reagent/buffer into the pipette tip 213 from a reagent or buffer vial. The diameter of the syringe of the automated syringe pump is a known constant. Accordingly, the linear distance Lv that the plunger of the automated syringe pump moves is proportional to the volume of fluids that are desired. The volume of fluids of reagent/buffer that can be chosen can be anywhere between one microliter and two hundred microliters inclusively. In some cases, volume of fluids of reagent/buffer that can be pumped is between five or ten microliters and two hundred microliters of reagent that can be delivered to each cocktail mixing tube. If five microliters of a reagent are chosen in a recipe for example, then with the pipette tip in the reagent, the syringe of the automated syringe pump is controlled by a control processor to move a first distance proportionally. If one hundred microliters of a buffer are chosen in a recipe for example, then with the pipette tip in the buffer, the syringe of the automated syringe pump is controlled by a control processor to move a second distance proportionally that is greater than the first distance. After a pipette tip has been used, it can be dismounted from the end effector 401 and discarded into the waste slot. Then, the syringe of the automated syringe pump can be reset to its starting point.

The pressure sensor 702 between the end effector 401 and the automated remote controlled syringe pump 700 can sense pressure variations Pdelta, changes in air pressure in the pump system to provide certain indications. For example, when drawing fluids in with a linear moving plunger, if the pressure sensor measures a decrease in air pressure, it can provide an indication that vial/container is nearing empty. Other techniques can be used to gain a sense of the fluid level in vials/containers before drawing fluid in from a reagent vial or buffer vial. In one case, the travel length of the pipette tip/end effector/syringe pump can be measured with the encoder of a servo motor from a calibrated top fluid level of container/vail to the estimate the volume of the fluid therein. In another case, with the pipette tip fully inserted or partially inserted into a vial/container, electrical capacitance can be measured between capacitor plates, at least one of which is formed in the pipette tip.

Referring to FIG. 7D, or fluid level sensing prior to aspirating fluids, the travel length of the pipette tip/end effector/syringe pump can be measured with a servo motor. A calibrated top point and a calibrated empty point can be predetermined from a predetermined vial shape and volume that is used. From a known calibrated point, such as the top of the container CT or the top of the fluid of a full volume of liquid in the container at a measured top level fluid point (MT) below the top level, measure of dead fluid level, can be used to calculate usable fluid level in a container. A top level of fluid can be electrically sensed by capacitance or mechanically sensed by air pressure. The pressure sensor and the end of the pipette tip 213 can be used to sense the top of the fluid in the vial/container. The syringe pump can blow air out of the orifice of the end effector into the pipette tip and out its end. From the calibrated top CT of the container/vial or a calibrated fluid level CF, a starting point of travel with respect to the pipette tip/end effector/syringe pump, the pipette tip is lowered into vial/container with air flowing out the end of the pipette tip. When the end of the pipette tip touches the top of the fluid, there is a pressure change that can be readily sensed by the pressure sensor 702. For electrical fluid level sensing, a capacitance meter can be used with one or two capacitor plates in the pipette tip to electrically measure changing capacitance and sense a top fluid level in a vial/container. If not in the pipette tip, the second capacitor plate can be another metal surface of the syringe pump or the metal block holding the vial/container for example.

Capacitance at the end of the pipette tip is measured by a capacitance meter with the end at the top of the vial/container. As the end of the pipette tip is moved from the top into the container towards the bottom of the container along the Z axis, the capacitance at the end of the pipette tip between two plates is continuously measured by the capacitance meter. When the end of the pipette tip touches the top level of the liquid, a significant change (increase such as by a multiple, e.g., 2×, 4×, 5×, 10×; or a decrease such as by a fraction, e.g., ½, ⅓, ¼, ⅛) in the measured capacitance can be detected by the capacitance meter and the position of the servo motor noted. Knowing the servo motor position at the top of the container and the servo motor position at the top liquid level, the dead height of the dead volume in the container can be determined by the difference of the two positions. Dead volume can be determined knowing the diameter/radius of the container. Fill volume can be determined from the difference of total volume and dead volume of the container. That is, a liquid volume in the reagent container can be determined by subtracting the dead volume from a predetermined total volume of the reagent container. The top level of fluid, however sensed, represents a measured point of travel into the vial/container by the Z servo motor 421 (see FIG. 4A) with respect to the pipette tip/end effector/syringe pump.

The travel length between the two points represents a height of the dead volume in vial/container from which the liquid volume can be computed. Generally, an encoder of the Z servo motor 421 generating the vertical movement of the pipette tip/end effector/syringe pump can be used to determine the travel length between the two points. With a predetermined height inside the open vial/container, the difference between the overall height and the travel length of dead volume can provide a measure of height of volume of the fluids in the vial/container that is proportional to the volume of fluid left.

Prior to using the automated pipettor system, the automated robotic arm 110 and the Z servo motor 421 can be calibrated to travel the overall height of the vial/container marking the calibrated top of the container CT and the calibrated bottom of the container CB or the calibrated top fluid level CF and the calibrated bottom of the container CB. The overall travel length LB or LF between each is known. To assist in the calibration, a test vial/container with a zero point sensor at its bottom can be used to determine when the bottom of the container has been reached. If the zero sensor is reached by the syringe pump and end effector moving to the Z zero limit position at the container bottom (CB), it will note that a vial is empty. Otherwise, the Z zero limit position can be set manually by a user by stopping the servomotor when the bottom is reached in a test calibration of the Z axis of vertical movement into and out of a vial/container. The encoder of the servomotor can provide travel length feedback and indicate when the Z zero limit position has been reached that indicates the bottom CB of the vial/container.

Referring to FIG. 7D, with the pipette tip 213 mounted to the end effector 401 of the syringe pump 450 and ready to be inserted into a vial/container 524,236 with a liquid, the pump blows air out from the end of pipette tip 213. As it is being lowered, when the end of pipette tip 213 first touches liquid inside the vial/container, the liquid restricts the opening causing increased air pressure in the syringe pump. The pressure sensor 702 can sense the positive increase in air pressure (a slight increase) and provide an indication when the end of the pipette tip 213 touches fluid. That is, when the pipette tip 213 is inserted into a vial/container 524,236, the pressure sensor 702 can provide an indication when the top surface (FT) of liquid is found in the vial/container 524,236.

The travel distance Lf1 that the pipette tip/end effector/pump are moved from a top of the vial CT into the vial/container to the top fluid point FT is monitored by the Z encoder or the Z servo motor and can provide a measure of the level of emptiness or dead volume/dead height (and the opposite—liquid fill level with total known height and volume) of the vial/container. For measuring dead volume or dead height and emptiness, the Z servo motor with its z encoder for the automated robotic arm of the automated robotic pipettor device 100 is periodically calibrated along the Z axis to the vials/containers in advance of making reagent cocktail mixtures. A plurality of calibrating vials/containers with specific fluid levels are positioned in the buffer/reagent racks, such as a full volume and an empty volume. The pipette tip can sense the fluidic levels in each of the plurality of calibrating vials/containers with the specific fluid levels and the z movement from the top fluid point FT measured by the z encoder of the Z servo motor can be recorded for each. For a full volume calibrating vial/container, the pipette tip is moved down the z axis from the container top to the top level of the full volume is reached with the Z encoder of the Z servo motor noted as the calibrated full volume position CF. For an empty volume calibrating vial/container, the pipette tip is moved down the z axis from the container top to the bottom of the container representing the empty level with the Z encoder of the Z servo motor noted as the calibrated empty volume position CB. Other volumes, such as ¾ full volume, ½ full volume, ½ full volume can be used with calibrating vials/containers and the Z encoder of the Z servo motor can be noted for calibrating points of these volumes. Knowing the calibrated Z positions for the full volume level and the empty volume level, the full fluid height can be determined for the calibrating vial/container. For the same vial shape, fill level positions in between full and empty can be calculated by ratioing the full fluid height and adding it to the full volume Z level position. For example, the ½ full volume position can be determined by multiplying (1½)=½ times the full fluid height and adding it to the z encoder position of the top full volume level position. As another example, the ¼ full volume position can be determined by multiplying (1¼)=¾ times the full fluid height and adding it to the z encoder position of the top full volume level position. As another example, the ¾ full volume position can be determined by multiplying (1¾)=¼ times the full fluid height and adding it to the z encoder position of the top full volume level position. Alternatively, further measurements with other calibrating vials/containers and volumes, such as ¾ full volume, ½ full volume, and ¼ full volume, can be performed. After calibration, volumes for a complete block/rack of vials/containers with the same shape can be measured knowing the Z encoder positions for the various levels as a pipette tip is inserted therein for aspiration of fluids.

When making the reagent cocktail mixtures and aspirating (drawing) buffers/reagents, the pressure sensor/pump/pipette tips will sense the top fluidic level, note the Z encoder value (providing a measure of the distance Ld under CF) of the Z servo motor for determining volume, and then move a predetermined distance (e.g., several millimeters—one to five millimeters) below the sensed top fluidics level to begin aspirating fluids into the pipette tip to aspirate a predetermined measure (e.g., five to ten milliliters) of reagent/buffer.

If the syringe pump is to suck in a large volume of reagent/buffer into the pipette tip, the syringe pump and pipette tip can concurrently aspirate and be moved down the z axis into the liquid of the vial/container at the same time. That is, the end of the pipette tip is concurrently moved along the Z axis of the automated robotic arm below the predetermined distance under the sensed liquid level of reagent/buffer in the reagent/buffer container or vial while aspirating more than the predetermined measure of reagent into the first pipette tip from the reagent/buffer container. This avoids drawing in air and reduces touches between tips. It can also provide better liquid aspiration accuracy and improved coefficient of variation (CV) between vials/containers, especially for aspirating small volumes of reagent/buffer below ten (10) microliters.

When making the reagent cocktail mixtures and aspirating (drawing) buffers/reagents, if the pipette tip/end effector/pump are moved along the z axis and reach the calibrated empty position at the container bottom (CB), the automated robotic pipettor device 100 will note that the vial/container is empty in the user interface to the user. A warning light can be displayed to the user to replace the empty vial/container if needed, so that the mixing can continue.

Based on measurements, calculations, and/or sensors determining a lower than full fill level but not empty, the icons of the buffer vials/containers and the reagent vials/containers in the graphic user interface (GUI) displayed on the monitor can be changed from a solid fill to a less than solid fill (e.g., ⅞ fill, ¾ fill, ½ fill, ¼ fill, ⅛ fill) to indicate their respective fluid level in the workspace to the end user. Based on the measurements, calculations, and/or sensors determining an empty condition, the icons of the buffer vials/containers and the reagent vials/containers in the graphic user interface (GUI) displayed on a monitor can be changed to zero fill with an icon effect (e.g., flashing empty and/or outlined colored—such as yellow) to indicate which ones are empty in the workspace to the end user. The status LED light 108 in the front bezzle can also flash and/or indicate a color such as yellow (not solid green) to show the automated robotic pipettor device 100 desires low level maintenance when one or more vials/reagents become empty.

A pipette tip can become clogged occasionally so that the flow of fluids is blocked through its center channel. The orifice and channel in the end effector can become blocked or clogged. If so, the negative air pressure or the positive air pressure measured by pressure sensor 702 is greater than a normal range of pressures. The pressure measured by the pressure sensor 702 can be monitored by the controller and compared with a pair of preset pressure values, a negative block pressure value and a positive block pressure value. If it is determined that the measured pressure of the pressure sensor 702 exceeds either of the negative block pressure value or the positive block pressure value, a blocked/clogged alarm can be issued to the user. The blocked or clogged alarm, indicating the blockage in the pipette tip or end effector, can be signaled (e.g., flashing red or flashing yellow, not solid green) by the status LED light 108 in the front of the system and by the user interface displayed on the display device 155 of the computer 150.

In FIG. 7D, the volume can also be estimated from the movement of the pipette tip/end effector/pump. The reagent vials/containers in the reagent racks/blocks are all of the same size and accordingly, from the known size of container (e.g., diameter and length of bottle Lb), a known total possible reagent volume can be calculated. The buffer vials/containers in the buffer rack/block are all of the same size but larger than the reagent vials/containers. Accordingly, from the known size of container, the buffer vials/containers also have a known total possible buffer volume that is greater than the known total possible reagent volume. Kinematics can help determine a volume in the vials/containers.

The Z servo motor moving the syringe pump 450 and end effector 401 (and any pipette tip mounted thereto) together in the automated robotic arm 110 of the automated robotic pipettor device 100 can be calibrated to know where the end of the pipette tip 213 reaches the start of the container top (CT) of the vials/containers 524,236 mounted in the racks/blocks 226,224. Accordingly, a linear distance Lf (the height of the “dead volume”) that the end of the pipette tip moves down from the container top (CT) into the vial/container to reach the top level of fluids (FT) can provide an indication how empty the vial/containers are of the reagent or buffer fluids. Knowing the full level volume in the vial/container, an approximate fill level can be computed from the level of emptiness determined from the kinematic movement of the end effector from the top to the initial detection of a fluid. The Z link servomotor provides travel length from the container top to the top fluid level. As fluid is drawn into the pipette tip, the pipette tip/end effector/pump may move further down into the vial/container. If the end of the pipette tip reaches the Z zero limit based on the travel determined from the servomotor, an empty indication of the respective vial/container can be provided to the user. An approximate fill level of liquid fluids in a vial/container may optionally be determined electrically.

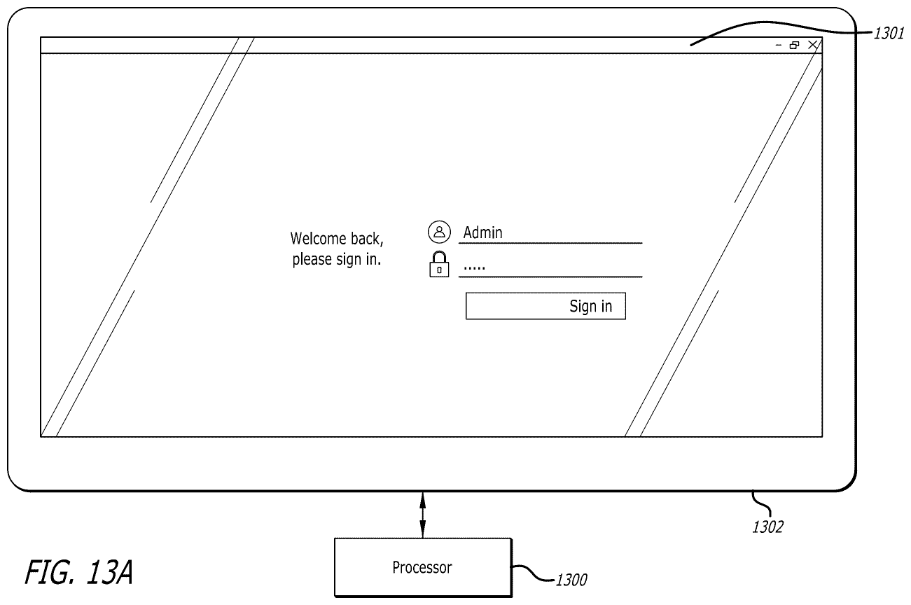

Referring momentarily now to FIGS. 10-11, a plastic hollow pipette tip 1000 is shown. FIG. 11 show the plastic hollow pipette tip 1000 mounted to the end effector of the syringe pump in the automated robotic arm. The plastic hollow pipette tip 1000 can also be referred to herein simply as a pipette tip; or as a robotic pipette tip or a disposable pipette tip because it removably mounts to (and dismounts from) an automated robotic arm and is disposable.

The plastic hollow pipette tip 1000 is generally formed of a plastic material but can include other additional features and materials. The plastic hollow pipette tip 1000 can be formed without electrical fluid level measuring means with fluid level measurements made mechanically using the automated robotic arm. In another case, the plastic hollow pipette tip 1000 can be formed with electrical fluid level measuring means.

The plastic hollow pipette tip 1000 can have one or two metal capacitor plates 1051A-1051B molded or embedded into the material (e.g., plastic) used to form its shape from the open tip end (first open end) 1011 up to the level of the filter 1020 insulating them from the fluid. One or more wires 1052A-1052B at one end can also be molded or embedded into the material of the pipette tip and coupled to respective ends of capacitor plates 1051A-1051B. Molding or embedding the wires and the capacitor plates into the material of the pipette tip insulates them from liquids in a buffer or reagent vial and keeps them from shorting out together so that capacitance can be measured. The wires can be respectively routed through the hollow conical frustrum portion 1001, the middle hollow circular cylinder portion 1002, and the top hollow circular cylinder portion 1003 to couple to one or more contact terminals 1053A-1053B in the plastic hollow pipette tip 1000. The one or more contact terminals 1053A-1053B in the plastic hollow pipette tip 1000 are adjacent the ringed lip 1004 can couple to one or more electrical terminals 1054A-1054B of the end effector 1100 when mounted as shown in FIG. 11. The location of the one or more contact terminals and the friction fit of the pipette tip to the end effector shields the one or more contact terminals from fluids and shorting out.

Electrical signals can be sent between the one or more capacitor plates and a control processor to obtain a measure of capacitance between the capacitor plates with an unknown volume of fluid therebetween. If one capacitor plate 1051A is molded into the pipette tip, the metal of the rack/block in which the vial/container is mounted can provide a second capacitor plate. Alternatively, the metal housing of the syringe pump 450 can provide a second capacitor plate. If two capacitor plates 1051A-1051B are molded into the pipette tip, the measure of capacitance may be more accurate with additional costs. The level of liquid fluid alters the capacitance between the two capacitor plates. Experiments can be run in advance to determine predetermined capacitance levels between capacitance plates with no fluid, full fluid level, and levels therebetween to which comparisons with the capacitance measurements can be made.

In any case, the approximate fill level can be determined and indicated in the graphical user interface of the control software so a user can know that a reagent bottle should be changed. A flag or signal light can turn yellow, and a warning can be displayed on the screen of the GUI explaining to the user that there is little to no reagent in a specific vial.

### Coaxial Mixer

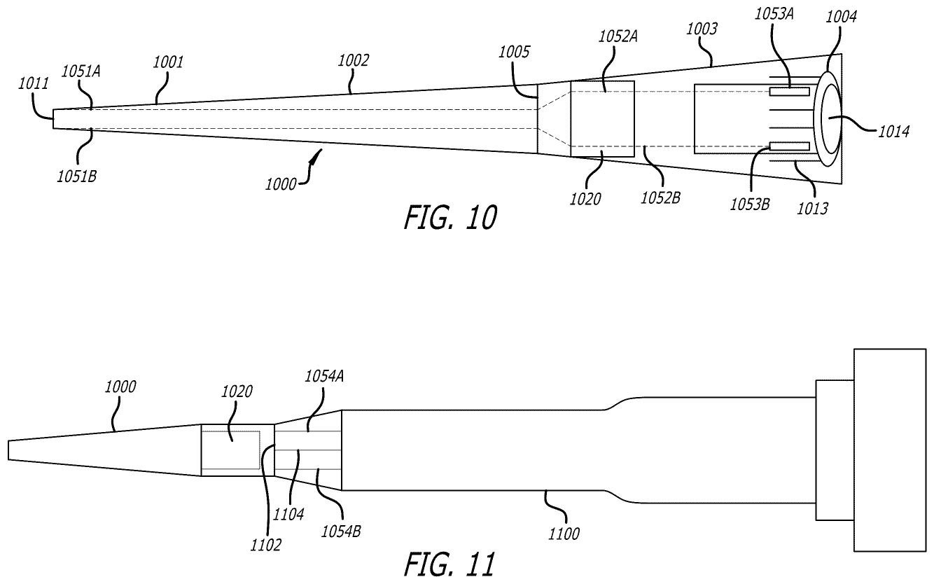

Referring now to FIG. 8, a view of top ends of mixture test tubes (containers) 802A-802B and removable tube holders 804A-804B is shown. The one or more coaxial mixers can accept 15 milliliter (ml) mixture test tubes 802A; 5 milliliter mixture test tubes 802B; and/or a combination thereof. A 15 milliliter removable tube holder 804A has a circular opening with an inner diameter to receive a 15 milliliter mixture test tube 802A. A 5 milliliter removable tube holder 804B has a circular opening with an inner diameter to receive a 5 milliliter mixture test tube 802B. The outer diameter of the removable tube holders 804A-804B is the same. The removable tube holders 804A-804B can be collectively referred to as removable tube holder 804 and test tubes 802A-802B can be collectively referred to as a test tube 802 knowing the proper removable tube holder is selected for the desired mixture test tube that is used. Other sizes of mixture test tubes can be accommodated by using other removable tube holders appropriately sized to engage the shaft of the electric motor.

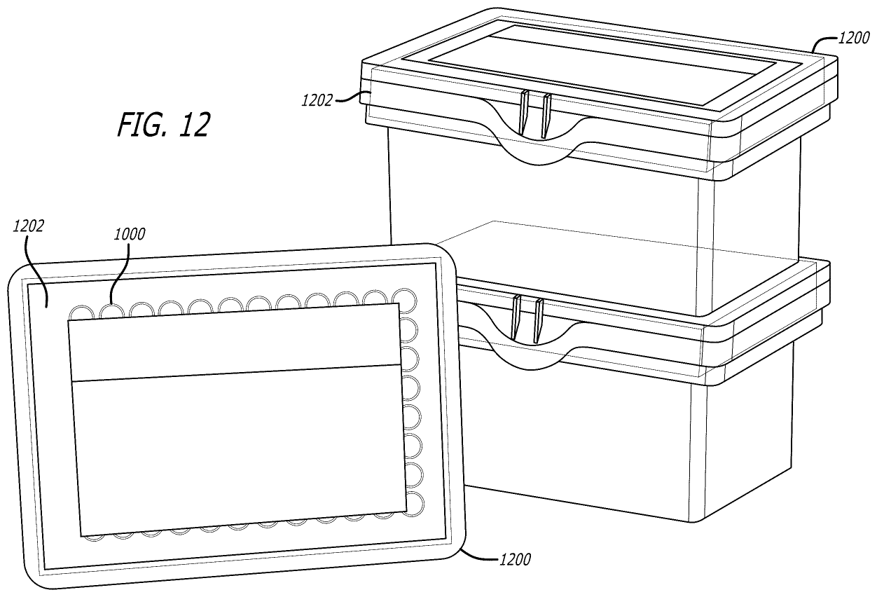

Referring now to FIG. 9, a cross section view of a coaxial mixer 900 with a mixture test tube 802,902 is shown. The coaxial mixer 900 includes a removable tube holder 804,904, a mix assembly adapter 906, a motor mount 908, and an electric motor 910. The mixture test tube 802,902 is inserted into a circular opening in the removable tube holder 804,904. The removable tube holder 804,904 is in turn is inserted into a circular opening in the mix assembly adapter 906 but spaced away to allow rotation. A rotatable shaft 912 of the electric motor 910 engages the removable tube holder 804,904. The nose end of the removable tube holder 804,904 includes a hollow cylindrical opening in its nose to receive a top portion of the rotatable shaft 912 of the electric motor 910.

The inner diameter of the opening in the mix assembly adapter 906 is shaped similar to the outer diameter of the removable tube holder 804,904 but leaves a gap so that the removable tube holder can rotate. The inner diameter of the circular opening in the removable tube holder 804,904 is similar to the outer diameter of the mixture test tube 802,902 that it receives. Regardless of the size of the test tube, the outer diameter of the removable tube holder 804,904 is the same providing a gap with the inner surface of the mix assembly adapter 906.

The electric motor 910 includes a rotatable shaft 912 to engage the removable tube holder 804,904 to spin the mixture test tube 802,902 and its reagent contents around a center spin axis 911. A center axis of each of the mixture test tube 802,902, removable tube holder 804,904, mix assembly adapter 906, and rotatable shaft 912 are coaxial along the center spin axis 911.

The electric motor 910 is electrically controlled. The electric motor 910 of the coaxial mixer can spin the mixture test tube 802,902 clockwise or counter clockwise about the center spin axis 911 in one case. In another case, the electric motor 910 of the coaxial mixer can spin the mixture test tube 902 clockwise or counter clockwise about the center spin axis 911, slow down to a stop, and spin the test tube in the opposite direction about the center spin axis 911 in order to agitate the reagent mix that is in the test tube.

Referring now to FIG. 10, a magnified perspective view of a plastic hollow pipette tip 1000 is shown. The plastic hollow pipette tip 1000 is representative instance of the plurality of pipette tips 213,430 discussed herein. The plastic hollow pipette tip 1000 has a first open end (open tip end) 1011 and a second open end 1014 opposite the first open end (open tip end) 1011. The second open end 1014 is configured to mount over an end effector of a syringe pump. The first open end (open tip end) 1011 is configured to be inserted into vials/containers to draw in (aspirate) measured portions of liquids, such as a reagent or buffer, and to be inserted into a test tube to push out the measured portions of liquids.

The plastic hollow pipette tip 1000 includes a hollow conical frustrum portion 1001 with the first open end (open tip end) 1011, a middle hollow circular cylinder portion 1002 in communication with the hollow conical frustrum portion 1001, a larger top hollow circular cylinder portion 1003 that necks down into a spherical segment joint 1005 coupled to the middle hollow circular cylinder portion 1002, and a ringed lip 1004 having one end coupled to another end of the top hollow circular cylinder portion 1003. The ringed lip 1004 has the second open end 1014 into the top hollow circular cylinder portion 1003. The top hollow circular cylinder portion 1003 has a larger inner diameter than the inner diameter of the middle hollow circular cylinder portion 1002.

The top hollow circular cylinder portion 1003 includes a plurality of external fins 1013 equally spaced apart around its external circular cylindrical surface. The plurality of external fins 1013 extend down a portion of the length of the top hollow circular cylinder portion 1003 away from the ringed lip 1004. The plurality of external fins 1013 are configured to support and suspend the top hollow circular cylinder portion 1003 of the pipette tip above a top surface of a rack. This makes it convenient to mount a plastic hollow pipette tip to the end effector of automated robotic arm.

The plastic hollow pipette tip 1000 can further include a filter 1020 in the top hollow circular cylinder portion 1003. The filter 1020 acts as a barrier to liquid that is sucked up into the hollow conical frustrum portion 1001 and the middle hollow circular cylinder portion 1002 of the plastic hollow pipette tip 1000. It deters the liquid and aerosols that may be formed from reaching the end effector 401 to avoid damage and cross-contamination when air flow is reversed. Each plastic hollow pipette tip 1000 and filter 1020 therein can be sterilized prior to usage and placed in a sealed sterilized container to avoid contaminating the reagents.

The external diameters of the top hollow circular cylinder portion 1003, the middle hollow circular cylinder portion 1002, and the hollow conical frustrum portion 1001 can slide into each tip opening in the tip plate. The plurality of external fins 1013 keep a top portion of the plastic hollow pipette tip 1000 from sliding through each tip opening in the tip plate. With the top portion of each pipette tip above the top surface of the tip plate, the end effector of the syringe pump and automated robotic arm can extend through the second open end 1014 and into a portion of the top hollow circular cylinder portion 1003 of the plastic hollow pipette tip 1000.

As shown in FIG. 11, an end portion of the end effector 1100 is friction fit into a portion of the top hollow circular cylinder portion 1003 of the plastic hollow pipette tip 1000. The top hollow circular cylinder portion 1003 of the plastic hollow pipette tip 1000 seals around the end portion of the end effector 1100. FIG. 7E shows a cross-sectional view of the tip end 751 of the end effector 401 with a pipette tip 213 mounted to the end portion of the end effector. The tip end 751 of the end effector includes an orifice 752. In FIG. 11, the end effector 1100 includes a metallic tip end with an opening (orifice) through which air can be evacuated up through the plastic hollow pipette tip 1000 to suck liquids into the open tip end (first open end) 1011 of the pipette tip. Air can also be forced out the opening (orifice) in the metallic tip of the end effector 1100 past the ringed lip 1004, through the second open end 1014, and into the plastic hollow pipette tip 1000 to push (force) out liquids near the open tip end 1011 of the plastic hollow pipette tip 1000. The diameter of the open tip end 1011 into the hollow conical frustrum portion 1001 is small. The small diameter of the open tip end 1011 and capillary forces can keep (retain or hold) the liquid (selected measure of reagent) within the plastic hollow pipette tip 1000 without air being evacuated. The opening (orifice) of the metallic end of the end effector 1100 is in communication with the syringe pump to receive positive air pressure and negative air pressure (vacuum) to respectively force liquids out and pull liquids into the plastic hollow pipette tip 1000.

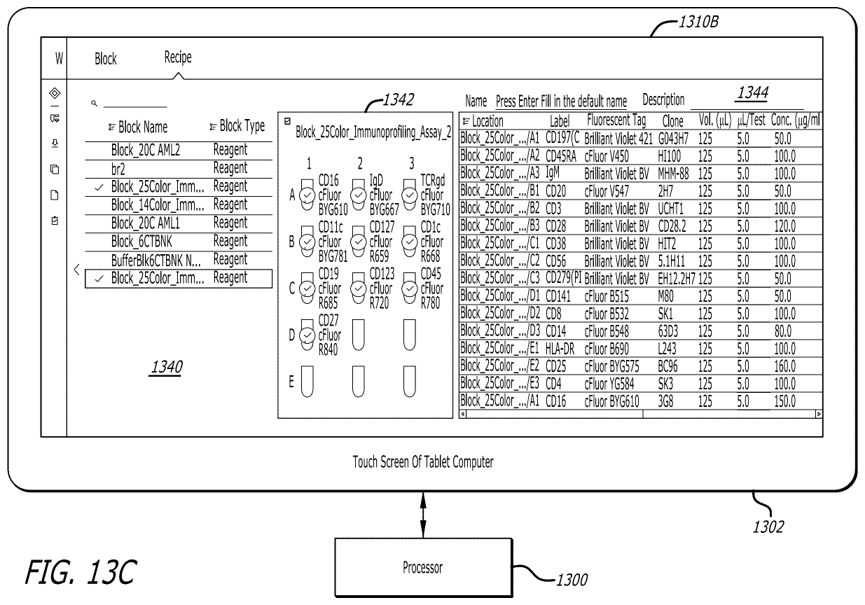

Referring now to FIG. 12, an X-Y array of a plurality of robotic plastic hollow pipette tips 1000 are mounted in a tray or rack 1202 and stored in a clear sealed box 1200. The clear sealed box 1200 is a sealable sterile container having a base and a lid. The base receives the tray or rack 1202 and the plastic hollow pipette tips 1000. The lid closes over the tray or rack 1202 and the plastic hollow pipette tips 1000 to seal over and keep them sterile until ready for use. The tray or rack 1202 is an instance of the one or more pipette racks 431 that can be installed into the automated robotic pipettor device 100.

In one embodiment, a maximum volume of each robotic plastic hollow pipette tip 1000 is two hundred microliters (200 ul). In one embodiment, each clear sealed box 1200 can hold ninety-six (96) robotic plastic hollow pipette tips 1000 in twelve columns and eight rows. In one embodiment, the automated robotic pipettor device 100 can receive one or two racks of robotic plastic hollow pipette tips 1000 so that either ninety-six or one hundred ninety-two robotic plastic hollow pipette tips are available for use.

The robotic plastic hollow pipette tips 1000 can be used once by the automated robotic pipettor device 100 to eliminate any carryover. The used robotic plastic hollow pipette tip 1000 then discarded automatically into the tip refuse container after usage. Methods can be used to use the same robotic plastic hollow pipette tip 1000 to deliver the same reagent to the three mixing tubes. Two small air bubbles can be used to isolate three reagent portions in the same robotic plastic hollow pipette tip 1000. A first portion of reagent is drawn into the robotic plastic hollow pipette tip 1000 by the automated syringe pump. The robotic plastic hollow pipette tip 1000 is momentarily lifted out of the reagent by the automated robotic arm to draw in a first air bubble. The robotic plastic hollow pipette tip 1000 is reinserted into the same reagent in the same vial and a second portion of the same reagent is drawn into the robotic plastic hollow pipette tip 1000 by the automated syringe pump. The robotic plastic hollow pipette tip 1000 is momentarily lifted out of the reagent once again by the automated robotic arm to draw in a second air bubble. The robotic plastic hollow pipette tip 1000 is reinserted into the same reagent in the same vial and a third portion of the same reagent is drawn into the robotic plastic hollow pipette tip 1000 by the automated syringe pump. The robotic plastic hollow pipette tip 1000 can then move over to three mixture test tubes and release one of the three portions into each.

### Automated Pipettor Graphical User Interface

The workflow to set up and use a pre-defined or a new cocktail recipe is straightforward and simple. A software wizard can guide users through adding reagents to the library, creating reagent deck settings, and creating cocktail recipes that can be saved and reused. Information about reagents, reagent deck settings, and cocktail recipes can also be uploaded from a comma separated values (CSV) file format. During cocktail preparation, the software can show the status of a worklist with indicators of tip usage, reagent usage, and steps completed or in process.

Cocktail recipes can be created using the reagents stored in the library or reagents entered into a quick cocktail module. The system includes data storage so that the software can save each reagent that is entered into a library for future use in creating reagent cocktail recipes. Cocktail reagent recipe templates can also be saved for reuse. Pre-programmed recipes associated with prepared immunoprofiling kits and assays with reagent vials/containers/tubes and buffer vials/containers/tubes can be used.

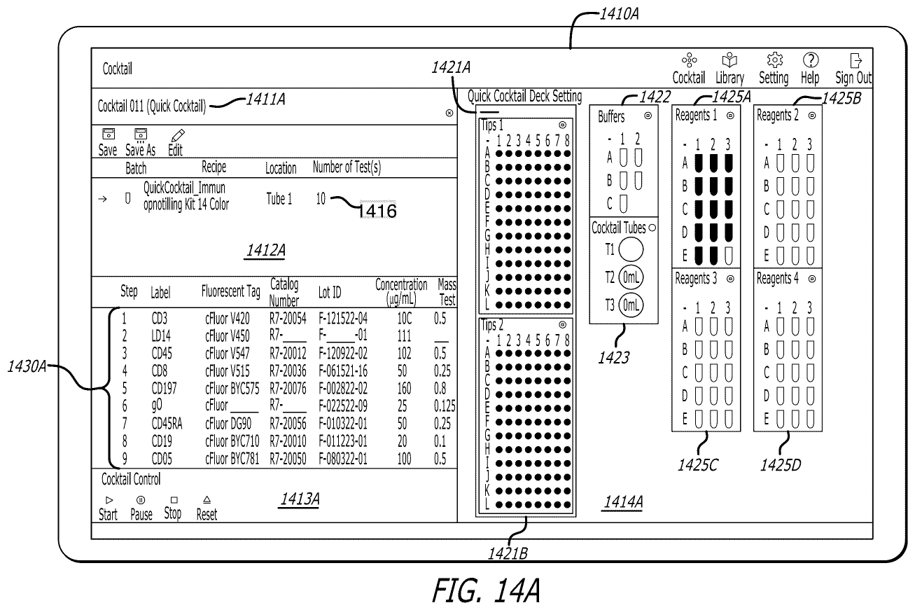

Referring now to FIG. 13A, a control processor 1300, with or without a graphics processing unit (GPU), is coupled to a display device 1302. The processor 1300, in communication with a storage device (e.g., memory) storing instructions, can execute the stored instructions of a software application to display different pages or windows of a graphical user interface (GUI) on the display device 1302 for the automated robotic pipettor device 100.

In FIG. 13A, a login window 1301 is displayed by the processor on the display device 1302. A user can input a user name and password in input fields of the login window and then select a sign in button to log into the automated robotic pipettor device 100. The software can interact with a database of information regarding reagent cocktail recipes, stored buffer information, and stored reagent information. A reagent cocktail recipe can be associated with a reagent kit including a plurality of reagent tubes and one or more buffer tubes. The reagent cocktail recipe indicates where the reagents and buffers should be put into each the respective rack/block. In some cases, all reagent racks are used. In other cases, one or more reagent racks are filled with different reagent vials.

Referring now to FIG. 13B, after logging into the automated robotic pipettor device 100, done of the GUI windows/pages is a reagent library window 1310A in which a user can select with a reagent button 1320 to display stored information about reagents. Information about cocktail recipes can be displayed to the user with selection of a cocktail recipe button 1322. Information about reagent deck settings of the automated robotic pipettor device 100 can be displayed with a reagent deck setting button 1324. Information about fluorescent tags or dyes can be displayed with a fluorescent tags button 1326. Information about labels can be displayed with a labels button 1328.

The reagent button 1320 is selected to view a table of reagents of the library in an information window 1321. New reagents can be added by selecting an add button with the GUI displaying a new reagent popup window 1330 to manually add and store information about a selected reagent that is desirable to use with the automated robotic pipettor device 100. A scanner application with a scanning device (e.g., a smartphone) can be used to scan a bar code (e.g., three dimensional or two dimensional bar code such as found on a box, a container, or a specification sheet of the reagent) in order to download and enter information more easily about a new reagent into the automated robotic pipettor device 100.

The new reagent popup window 1330 includes data entry fields 1331-1339 respectively for reagent name, catalog number, fluorescent tag, label, clone, test count in the vial, concentration (e.g., micrograms per milliliter), volume per test (e.g. microliters), and a description field for entry of information about the new reagent and its purpose. One entered into the library, the reagent can be readily called into a new or different panel for a different flow cytometry experiment. The new reagent popup window 1330 includes a save button to save the information about the new reagent in the library. The new reagent popup window 1330 includes a cancel button to discard the information and close the new reagent window without adding information to the library.

Referring now to FIG. 13C, the cocktail recipe button is selected to display a reagent recipe GUI window 1310B. The reagent recipe GUI window 1310B displays a list window 1340 of block/rack names associated with block/rack types of either of reagent blocks/racks or buffer blocks/racks. For a selected block name, a virtual block window 1342 of a virtual reagent block or a virtual buffer block is displayed that is associated with a reagent block and a buffer block of the automated robotic pipettor device 100. The virtual reagent block displays a block name at top with reagent names (label and fluorescent tag) and their associated positions in the array of the block. A virtual buffer block displays a block name at top with buffer names and their associated positions in the array of the block. As vials/containers are inserted into a position of a block, the virtual display checks off that it has been placed into its position.

For the selected block name, a reagent window 1344 is also displayed that lists detailed information regarding the reagents in the specific reagent block or detailed information regarding the buffers in the buffer block. For an experiment, there can be multiple virtual reagent blocks and one buffer block that can be displayed by the selecting them from the list window. Block names in the list generally include the experiment name after “Block” so that the multiple virtual blocks and the buffer block of an experiment can be readily associated together. Each row of the list displayed in the reagent window 1344 includes block name/location, label, fluorescent tag, clone name, liquid volume of vial, liquid volume per test used, and concentration for each reagent vial.

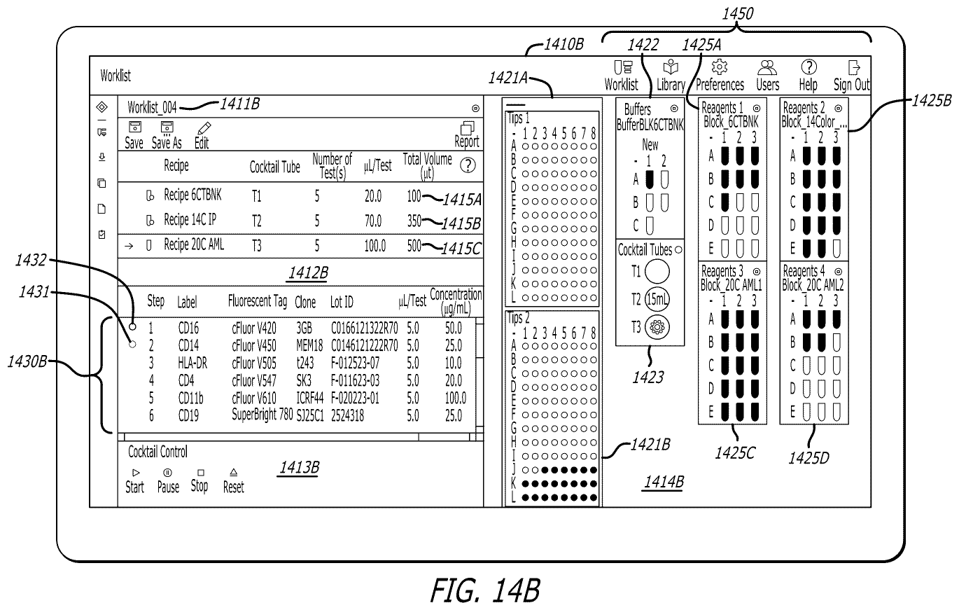

Referring now to FIG. 14A, a cocktail window 1410A is generated by the processor 1300 and displayed by the display device 1302. Reagent cocktail recipes can be shown by selecting the cocktail recipe button 1322 in reagent library window 1310A of FIG. 13B. A list of cocktail recipes can be displayed in the cocktail window 1410A by the processor 1300 and the display device 1302.

By selecting a particular cocktail recipe, such as “cocktail 011”, for example, information about the selected reagent cocktail recipe 1411A can be displayed in one or more information area windows 1412A,1413A,1414A of the cocktail window 1410A. One or more of the information area windows can display one or more batch experiments that can run with the automated robotic pipettor device in a batch information area window 1412A, the plurality of steps 1430A,1430B of the selected reagent cocktail recipe 1411A in a recipe information area window 1413A, and visible positions of reagents/buffers and test tubes in a cocktail deck setting window 1414A for the automated robotic pipettor device 100.

In the batch information area window 1412A, rows of the batches to be run with the automated robotic pipettor device 100 can be displayed. For each batch that is to run, each row 1416 of the batch information area window 1412A can display a batch name, a recipe name, mixture (mixing) test tube number(s), the number of tests run for the flow cytometry experiment, the fluid use per test, and total volume used for an experiment. With a recipe selected in a row 1416 from the batch information area window 1412A, further information can be displayed about the selected recipe in the cocktail window 1410A.

In the recipe information area window 1413A, a plurality of ordered reagent mixing steps 1430A for the given batch test are displayed that are to be performed by the automated robotic pipettor device 100. Each step represents a selected reagent or buffer and can include displaying step number, marker/label, fluorescent tag, catalog number, lot ID, fluid used per test, and concentration.

In the cocktail deck setting window 1414A, virtual images can be used to show the number of pipette tips, buffer vials, reagent vials, and mixture test tubes that are to be set up for the selected reagent cocktail recipe. Virtual images of a first array (Tips 1) of a plurality of pipette tips 1421A, a second array (Tips 2) of a plurality of pipette tips 1421B, a buffer rack/block 1422, a cocktail mixing tube rack/block 1423, and a plurality of reagent racks/blocks 1425A-1425D can be displayed in the cocktail deck setting window 1414A.

Before mixing, the virtual images of filled in icons shows positions of vials, test tubes, and pipette tips that are to be mounted in an associated rack or test tube holder and an unfilled icon outline shows positions that are vacant. Since mixing has yet to occur, the virtual images (pipette tip icons) of the arrays of the plurality of pipette tips 1421A-1421B are filled in at each position in the arrays. The virtual image (vial icon) of the buffer rack/block 1422 shows positions of buffer vials filled-in that are to be mounted. The virtual image (circle test tube icon) of the cocktail mixing tubes rack/block 1423 shows a circle icon of test tube 1 filled where a test tube is to be mounted. Mixture test tube 2 and mixture test tube 3 are unused in this recipe so they are not filled-in or have a none symbol or icon such as a cross through, a strike through, or an X marked inside the circle icon where a test tube need not be mounted. The virtual image (vial icon) of the reagent block 1425A shows all positions but one vial icon filled that are to be mounted. The virtual images of the reagent blocks 1425B-1425D show all positions empty (outline vial icon with no fill) indicating that no vial is mounted in those positions because they are unused with this reagent cocktail recipe.

Referring now to FIG. 14B, a worklist window 1410B is generated by the processor 1300 and displayed by the display device 1302. At the top menu bar of some GUI windows for the automated robotic pipettor device 100, there are one or more control buttons 1450 including one or more of a worklist button or cocktail button, a library button, a preferences or setting button, a user's button, a help button, and a sign out button. In FIG. 14B, a worklist button has been chosen to display the worklist window 1410B. In FIG. 14A, a cocktail button has been chosen to display the cocktail window 1410.

The worklist window 1410B shown in FIG. 14B is displayed in context of the automated robotic pipettor device 100 making one or more selected reagent cocktail recipes. The worklist window 1410B can display the worklist name/number 1411B near the upper left corner with save and save as buttons below it. The worklist window 1410B includes a recipe job list window 1412B, a recipe list window 1413B, and a cocktail deck status window 1414B.

In the recipe job list window 1412B, one or more recipe jobs 1415A-1415C can be listed with the active one being highlighted by an arrow and color highlighting of a row for display to the user.

In context, the recipe being worked is shown in the recipe list window 1413B. The recipe list window 1413B illustrates the multiple steps 1430B of a selected recipe that the automated robotic pipettor device 100 is working on. A status icon can be indicated next to each step in the step column in the recipe. A check mark icon 1432 adjacent a step in the step column indicates that the step has been completed. A ring icon 1431 adjacent a step in the step column indicates a step that is currently being processed. No icon or a blank icon adjacent steps in the step column indicates steps that have yet to be started or completed. Besides the status icon, each row in a recipe list window 1413B can include a step number, a label name, a fluorescent tag, a clone name, a lot identification, the reagent volume per test (microliters per test), and the reagent concentration (micrograms per milliliter).

In a cocktail deck status window 1414B, based on the mounting of vials/containers/tubes set up for a recipe using the cocktail window 1410A, virtual images can show usage status as a cocktail reagent recipe is being mixed by the automated robotic pipettor device 100 through various icons and symbols. The usage status is shown by the virtual images of usage status icons for pipette tips 1421A,1421B, virtual images of usage status icons for the buffer rack/block 1422, virtual images of usage status icons for the mixture test tubes in rack/block 1423, and virtual images of usage status icons for the reagent tubes in racks/blocks 1425A-1425D as a cocktail reagent recipe is being mixed by the automated robotic pipettor device 100.

A filled shaded circle and an empty circle are used as usage status icons for the pipette tips. The filled circle (presence) usage status icons indicate pipette tips that remain present in the pipettor rack in the automated robotic pipettor device 100. An empty circle (absence) usage status icons indicating they are absent because they were already used and discarded. For example, the virtual image of the second array (Tips 2) of plurality of pipette tips 1421B shows a lower three rows with filled circle usage status icons indicating that pipette tips are remaining (present) in these positions have yet to be used by the automated robotic pipettor device 100. The remaining locations for pipette tips 1421B in the second array are virtually displayed with an empty circle (absence) usage status icons indicating they are absent because they were already used and discarded. All of the locations for pipette tips in the first array (Tips 1) of a plurality of pipette tips 1421A are virtually displayed by empty circle icons to indicate their absence because they were used and discarded. As more pipette tips are used from the pipette racks by the automated robotic pipettor device 100, each location of the filled circle icons are changed to display empty circle icons to provide real time feedback to a user.

A filled vial symbol, an empty vial symbol, and different partially filled vial symbols can be used as usage status icons to indicate the mounted/volume usage status of a buffer. In the buffer rack/block 1422, the filled vial symbol (mounted/volume usage status icon) in one location (A1) indicates a buffer vial being used in the recipe. The empty (outlined) vial symbols (unmounted usage status icons) in the other locations (A2,B1,B2,C1) indicate no buffer vial is in use in those locations of the buffer block for the recipe. As the vials are used, the fill of the symbol (mounted/volume usage status icon) can be reduced in the vial icon outline to show the approximate volume remaining in a vial. This change to vial icons as they are used provides real time feedback to a user of the operation of the automated robotic pipettor device 100.

Similarly, a filled vial symbol, an empty vial symbol, and different partially filled vial symbols can be used as usage status icons to indicate the mounted/volume usage status of a reagent. The plurality of reagent blocks 1425A-1425D can be displayed with filled vial symbols (mounted/volume usage status icons) to show locations of reagent vials that are used in the recipe and empty (outlined) vial symbols (unmounted usage status icons) to show locations where no reagent vials are used. The fill of a vial symbol (mounted/volume icon) can be animated to show current use. The amount of fill in the vial symbol can be varied to show the user the approximate volume remaining in a vial after the automated robotic pipettor device 100 has used some reagent liquid in the mixture test tube for a test or flow cytometer run.

A shaded of filled circle, an empty circle, and a spinning icon can be usage icons that respectively show a mounted test tube, no mounted test tube, and a spinning test tube. The cocktail test tube rack/block 1423 shows the loading (mounted icon) of one mixture test tube in position T3 of the automated robotic pipettor device 100 by shading (fill) inside a circle. In positions T1 and T2 of the cocktail test tube rack/block 1423, the circle where a test tube would be indicated as mounted is empty showing an outline (unmounted icon), indicating that no test tube is being used in those positions in the test tube block of the automated robotic pipettor device 100. Animation can be added to the shading (fill) of the circle in position T3, such as by a spinning semicircle arrangement of bubbles in the fill (mounted/mixing icon), to show the coaxial spinning of the test tube and mixing of the reagents in the automated robotic pipettor device 100.

### Computer Network

The automated robotic pipettor device 100 can be part of an automated reagent cocktail mixing system with one or more remote computer systems coupled in communication via a computer network. The processor of the automated robotic pipettor device 100 can be connected to the computer network by a network interface device (NIC) by wired cable (Ethernet) with a network connector or by wireless means with a wireless (WIFI) radio transceiver device. Remote control access to the GUI control software of the automated robotic pipettor device 100 can be provided to authorized users (login identification, password, verification) at the remote computer system in communication therewith via a local area network (LAN) connection (by WIFI wireless or Ethernet cable) or to a remote computer system in communication therewith via a wide area network (WAN) connection (by wireless WIFI radio or wired Ethernet cable). The remote computer system can be a mobile computer such as a laptop computer, or a smart phone in communication with the processor of the automated robotic pipettor device by means of a wireless communication network (e.g., cellular wireless communication network) and/or a worldwide communication network (e.g., internet).

Notifications of work in process by the automated robotic pipettor device 100 can be communicated to authorized users at the local, remote, or mobile computers. Similar graphical user interfaces can be provided on display monitors of the remote computer system to authorized users in order to remotely control and/or monitor the automated robotic pipettor device 100 and the mixing of the selected reagent recipes. For example, a smartphone application (app) executed by a mobile computer coupled in remote communication with the automated robotic pipettor device 100 with controlled access to authorized users can provide similar GUI windows described herein. The GUI windows of the smartphone app can be provided to allow the mobile computer (e.g., smart phone) to remotely monitor progress of selected cocktail recipe jobs and provide notifications to a user. A user can be notified when an anomaly or problem occurs with the automated robotic pipettor device 100. A user can be notified when a job is completed with the automated robotic pipettor device 100. This allows a user to be more efficient and perform other tasks in a laboratory while the mixture test tube is being prepared.

### Operation

In operation, the automated robotic arm is moved to draw up one reagent with a first short pipette tip and then release it into one of three of mixture test tubes where the cocktail recipe is made. If the same reagent is used with another test tube, the first pipette can be reused with the same reagent. Otherwise, the first pipette tip can also be ejected from the end effector after usage and discarded into a hidden container. When a different reagent is needed in the step of a recipe, the prior detachable short pipette tip is ejected and discarded through an opening into a waste container hidden in the base. A new detachable short pipette tip can then be attached to the end effector of the automated robotic arm. Changing out the short detachable pipette tips avoids cross contamination. After a recipe is completed, the discarded pipette tips in the hidden container can be disposed of manually by user.

With a second short pipette tip attached, the automated robotic arm is moved over the deck to draw in a next reagent from a reagent vial. With the next reagent loaded into the pipette tip, the robot arm may move it over to the same or different cocktail mixture test tube and then release it into that test tube. With many pipette tips, this process can be repeated over and over again for as many times as the multiparameter cocktail recipe calls for different reagents and different buffers for the three mixtures tubes.

Each of the three mixture tubes can be coaxially spun or rotated by a coaxial mixer. The coaxial mixer is not a centrifuge. Each of the three mixture tubes can rest into a removable tube holder of the coaxial mixer that can be rotated along a center spin axis by an electric motor under each. The spinning of the test tube along the center spin axis stirs the chemical reagent mix to uniformly mix the liquid contents therein. The coaxial spinning of the mixture test tube is not equivalent to that of a centrifuge that uses centripetal force to move solids towards a bottom of a test tube with the liquid isolated above the solids.

The software user interface, generated by software instructions, a processor, and displayed by a monitor, graphically indicates the positions of the reagents, the pipettes, and the cocktail and/or buffer tubes that are being used. It notifies the user of instrument start up, status and completion.

The automated robotic arm is not handling the test tubes themselves. The goal of the automated robotic arm is to automate the pipetting steps that a human might otherwise have to manually perform with a larger number of reagents.

Note that no patient blood or biological cells are used or pipetted in the operation of the automated pipettor/mixing device. The automated pipettor/mixing device prepares the reagent cocktails in mixture test tubes for a flow cytometer before adding the biological cells that are to be tested. The blood samples are subsequently deposited by manual means external to the automated pipettor mixing device.

Reagent kits of a plurality of reagents and a software reagent recipe template can be provided together to work with the automated robotic pipettor device to further improve workflow in preparing reagent mixtures for certain testing of biological cells.

### Advantages

The automated reagent cocktail preparation system has a number of advantages. It improves workflow efficiency for flow cytometry experiments (reagent panels) by avoiding the manual steps of mixing reagents together into test tubes. The automated robotic arm of the automated reagent cocktail preparation system robotic eliminates repetitive manual pipetting motions when making a reagent cocktail mixture for high dimensional panels with numerous reagents. The automated reagent cocktail preparation system eliminates potential user errors and manual pipetting mistakes when making reagent cocktail mixes. The automated reagent cocktail preparation system can more quickly make a reagent cocktail mixture in accordance with a reagent recipe and save precious lab time.

The automated robotic pipettor device keeps reagents stable when mounted into the reagent racks through cooling, light protection, and gentle mixing of the reagent cocktail mixture. Cooled racks are provided to ensure reagent and buffer stability. Cooled removable test tube holders are provided for the mixture tubes to ensure cocktail mixture stability.

Reagent kits and reagent recipes can be provided to function with the automated robotic pipettor device to further ease reagent mixture preparation for predetermine flow cytometry experiments. A reagent library provides easy access to reagent mixture recipes to load into the automated robotic pipettor device. Custom reagent panels with associated custom reagent recipes can be designed and loaded into the reagent library for use with the automated robotic pipettor device. Procedural Information can be stored into storage of the controller with the reagent panel for quick application access.

### Closing Remarks

The embodiments are thus described. While embodiments have been particularly described, they should not be construed as limited by such embodiments but rather construed according to the claims that follow below.

While certain exemplary embodiments have been described and shown in the accompanying drawings, it is to be understood that such embodiments are merely illustrative of and not restrictive on the disclosed embodiments, and that the disclosed embodiments are not limited to the specific constructions and arrangements shown and described, since various other modifications may occur to those ordinarily skilled in the art.

When implemented in software, the elements of the software aspect are essentially the code segments to perform the necessary tasks. The program or code segments can be stored in a processor readable medium to be read out by a processor for execution. The code segments can be downloaded into a processor readable medium or storage device via computer networks such over the Internet, Intranet, etc. The processor readable medium may include any medium that can store information. Examples of the processor readable storage medium include an electronic circuit, a semiconductor memory device, a random access memory (RAM), a read only memory (ROM), a flash memory, an erasable programmable read only memory (EPROM), a floppy diskette, a CD-ROM, an optical disk, a magnetic hard disk, or other type of data storage device.

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1-28. (canceled)

29. An automated reagent cocktail mixer comprising:
at least one ordered matrix pipette tip stand to hold a plurality of hollow disposable pipette tips;
an ordered matrix reagent stand to hold a plurality of reagent containers;
one or more rotatable test tube stands to hold one or more test tubes;
a robotic arm having an end effector to pick up and engage with a plurality of hollow disposable pipette tips to move them over, in to, out of, and between open ends of the plurality of reagent containers and open ends of the one or more test tubes, the end effector including an orifice to allow air flow into and out each respective one of the plurality of hollow disposable pipette tips; and
an automated syringe pump in communication with the orifice of the end effector, the automated syringe pump to draw measured portions of selected reagents from open ends of selected reagent containers into the plurality of hollow disposable pipette tips, the automated syringe pump further to expel the measured portions of the selected reagents from the plurality of hollow disposable pipette tips into at least one open end of the one or more test tubes.

30. The automated reagent cocktail mixer of claim 29, wherein the plurality of hollow disposable pipette tips with expelled reagents are a plurality of used hollow disposable pipette tips and the reagent mixer further comprises:
a waste container having a waste opening to receive the plurality of used hollow disposable pipette tips,
wherein the robotic arm moves the plurality of used hollow disposable pipette tips over the waste opening and the end effector releases the plurality of used hollow disposable pipette tips to drop into the waste container.

31. The automated reagent cocktail mixer of claim 29, further comprising:
an ordered buffer stand to hold one or more buffer containers.

32. The automated reagent cocktail mixer of claim 30, further comprising:
a control processor coupled in communication with the robotic arm and the automated syringe pump;
wherein the control processor controls the robotic arm and the automated syringe pump to mix a selected reagent cocktail recipe into the one or more test tubes with a plurality of reagents from the plurality of reagent containers and one or more buffers from the one or more buffer containers.

33. The automated reagent cocktail mixer of claim 29, further comprising:
a housing with a deck and an inner platform coupled to the deck, the inner platform to receive the at least one ordered matrix pipette tip stand, the deck to receive the ordered matrix reagent stand and the one or more rotatable test tube stands; and
a hinged cover pivotally coupled to the deck, the hinged housing covering over portions of the plurality of reagent containers, and the one or more test tubes, the hinged housing having a top portion with an opening over each of the plurality of reagent containers, and the one or more test tubes through which an open tip end of the plurality of hollow disposable pipette tips can extend.

34. The automated reagent cocktail mixer of claim 32, further comprising:
a housing with an inner platform to receive the ordered matrix pipette tip stand, the ordered matrix reagent stand, and the one or more rotatable test tube stands; and
a hinged cover pivotally coupled to the inner platform, the hinged cover covering over portions of the one or more buffer containers, the plurality of reagent containers, and the one or more test tubes, the hinged cover having a top portion with an openings over each of the one or more buffer containers, each of the plurality of reagent containers, and the one or more test tubes through which an open tip end of the plurality of hollow disposable pipette tips can extend.

35. The automated reagent cocktail mixer of claim 34, further comprising:
an electric chiller under the inner platform, the electric chiller in communication with the ordered buffer stand and the ordered matrix reagent stand to chill and preserve liquid contents in the one or more buffer containers and the plurality of reagent containers.

36. The automated reagent cocktail mixer of claim 35, wherein:
the electric chiller is further in communication with the one or more rotatable test tube stands to chill and preserve liquid contents in the one or more test tubes.

37. The automated reagent cocktail mixer of claim 35, further comprising:
a control processor coupled in communication with the electric chiller; and
a temperature sensor coupled in communication with the control processor, the temperature sensor to provide temperature feedback to the control processor;
wherein the control processor controls the electric chiller to meet a selected temperature based on the temperature feedback.

38. The automated reagent cocktail mixer of claim 29, further comprising:
one or more electric motors respectively coupled to a base of the one or more rotatable test tube stands, the one or more electric motors to rotate the one or more test tubes in the one or more rotatable test tube stands to uniformly mix liquid contents in the one or more test tubes.

39. The automated reagent cocktail mixer of claim 29, further comprising:
a channel coupled in communication with the orifice of the end effector and a barrel of the automated syringe pump, the channel to communicate negative air pressure with a hollow disposable pipette tip mounted to the end effector to draw the measured reagent therein, the channel to communicate positive air pressure with the hollow disposable pipette tip to expel the measured reagent there from.

40. The automated reagent cocktail mixer of claim 29, wherein the robotic arm includes:
a rotatable drip tray adjacent the end effector, the rotatable drip tray configured to rotate under an end of a mounted hollow disposable pipette tip to catch leaking drips and avoid cross contamination of reagents.

41. The automated reagent cocktail mixer of claim 33, wherein the housing further includes a front opening, and the automated reagent cocktail mixer further comprises:
a hinged front door to close over the front opening of the housing, wherein the hinged front door includes a semi-transparent portion to see movement of the robotic arm within the housing.

42. The automated reagent cocktail mixer of claim 34, wherein the housing further includes a front opening, and the automated reagent cocktail mixer further comprises:
a hinged front cover to close over the front opening of the housing, wherein the hinged front cover includes a semi-transparent portion to see movement of the robotic arm within the housing.

43. An automated reagent cocktail mixing system comprising:
an automated reagent cocktail mixing device including:
at least one ordered matrix pipette tip stand to hold a plurality of hollow disposable pipette tips;
an ordered matrix reagent stand to hold a plurality of reagent containers;
one or more rotatable test tube stands to hold one or more test tubes;
a robotic arm having an end effector to pick up and engage with a plurality of hollow disposable pipette tips to move them over, in to, out of, and between open ends of the plurality of reagent containers and open ends of the one or more test tubes, the end effector including an orifice to allow air flow into and out each respective one of the plurality of hollow disposable pipette tips; and
an automated syringe pump in communication with the orifice of the end effector, the automated syringe pump to draw measured portions of selected reagents from open ends of selected reagent containers into the plurality of hollow disposable pipette tips, the automated syringe pump further to expel the measured portions of the selected reagents from the plurality of hollow disposable pipette tips into at least one open end of the one or more test tubes.

44. The automated reagent cocktail mixing system of claim 43, wherein the automated reagent cocktail mixing device further includes:
a display monitor to display a graphical user interface;
a storage device to store instructions for execution; and
a processor coupled in communication with the display monitor, the storage device, the one or more rotatable test tube stands, the robotic arm, and the syringe pump, the processor to execute instructions stored in the storage device to perform functions to:
control the robotic arm and the syringe pump to mix a selected reagent cocktail recipe into one or more mixture test tubes mounted in the one or more rotatable test tube stands,
display a graphical user interface on the display monitor to select the selected reagent cocktail recipe that is to be mixed into the one or more mixture test tubes and display a status of the automated reagent cocktail mixing system as the selected reagent cocktail recipe is being made, and
control the one or more rotatable test tube stands to rotate the one or more mixture test tubes.

45. The automated reagent cocktail mixing system of claim 44, wherein the automated reagent cocktail mixing device further includes:
an electric chiller in communication with the processor; and
a temperature sensor in communication with the processor;
wherein the processor is to further execute instructions stored in the storage device to perform functions to control the electric chiller to chill the one or more rotatable test tube stands to a selected temperature setting that is sensed by the temperature sensor, such that the one or more mixture test tubes and one or more liquid mixtures therein are chilled to preserve the one or more liquid mixtures.

46. The automated reagent cocktail mixing system of claim 44, wherein the automated reagent cocktail device further includes a network interface device coupled in communication with the processor, and the system further comprises:
a computer system operated coupled in communication with the network interface device of the automated reagent cocktail device;
wherein the processor of the automated reagent cocktail device is to further execute instructions stored in the storage device to perform functions to control the network interface device to communicate with the computer system and display a graphical user interface to one or more authorized users on a display device of the computer system for remote communication and control of the automated reagent cocktail device in the mixing of selected reagent cocktail recipes.

47. An apparatus comprising:
a display monitor to display a graphical user interface;
a storage device to store instructions for execution;
a processor coupled in communication with the display monitor and the storage device, the processor to execute instructions stored in the storage device to perform functions to display the graphical user interface on the display monitor, the functions including:
before mixing buffers and reagents with an automated reagent cocktail mixer, displaying a reagent recipe window on the display monitor for a flow cytometer experiment with directions to:
mount buffer containers with one or more buffers into a buffer rack of the automated reagent cocktail mixer, and
mount reagent containers with differing reagents into one or more reagent racks of the automated reagent cocktail mixer.

48. The apparatus of claim 47, wherein the reagent recipe window includes:
a list of block names for a buffer rack and each rack of a plurality of reagent racks in an automated reagent cocktail mixer;
a virtual block window of a virtual reagent block or a virtual buffer block associated with a selected block associated with a selected block name, the virtual reagent block or the virtual buffer block illustrating a plurality of container icons with reagent names or buffer names adjacent filled container icons that are to be mounted into the selected block associated with the selected block name that is to be filled and no name adjacent empty container icons that are not to be mounted into the selected block associated with the selected block name; and
a reagent window or a buffer window associated with the selected block name, the reagent window listing detailed information regarding the plurality of reagents to be mounted in a selected reagent block and the buffer window listing detailed information regarding the one or more buffers to be mounted in the buffer block.

49-72. (canceled)
